(19) United States
(12) Patent Application Publication
(10) Pub. No.: US 2021/0389137 A1
(43) Pub. Date: Dec. 16, 2021

(54) Systems and Methods for Integrating Autonomous Vehicles and Light Electric Vehicles

(71) Applicant: UATC, LLC, San Francisco, CA (US)

(72) Inventor: Philipp Haban, San Francisco, CA (US)

(21) Appl. No.: 16/920,873

(22) Filed: Jul. 6, 2020

Related U.S. Application Data
(60) Provisional application No. 63/039,738, filed on Jun. 16, 2020.

(51) Int. Cl. G01C 21/34; B60W 60/00

(52) U.S. Cl. CPC G01C 21/3407; B60W 60/0025; G01C 21/3469

(57) ABSTRACT

Systems and methods for coordinating multimodal transportation services are provided. An example computer-implemented method includes obtaining a service request for a vehicle service indicating an origin location and a destination location. The method includes determining a route from the origin location to the destination location. The method includes segmenting the route into a plurality of route segments, each of which comprise a first route segment that is traversable by an autonomous vehicle and a second route segment that is traversable by a light electric vehicle. The method includes determining an autonomous vehicle to provide the vehicle service along the first route segment. The method includes determining a light electric vehicle to provide the vehicle service along the second route segment and to accompany the autonomous vehicle along at least a portion of the first route segment. The method includes outputting data associated with the service request for the autonomous vehicle.

### RELATED APPLICATION

The present application is based on and claims benefit of U.S. Provisional Patent Application No. 63/039,738 having a filing date of Jun. 16, 2020, which is incorporated by reference herein.

### FIELD

The present disclosure relates generally to a multi-modal transport systems. In particular, the present disclosure relates to the coordination of multiple vehicles to provide a single vehicle service.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given such knowledge, an autonomous vehicle can navigate through the environment.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method. The method includes obtaining, by a computing system including one or more computing devices, a service request for a vehicle service. The service request is indicative of an origin location and a destination location. The method includes determining, by the computing system, a route from the origin location to the destination location. The method includes segmenting, by the computing system, the route into a plurality of route segments. The route segments include a first route segment that is traversable by one or more autonomous vehicles and a second route segment that is traversable by one or more light electric vehicles. The method includes determining, by the computing system, an autonomous vehicle of the one or more autonomous vehicles to provide the vehicle service along the first route segment. The method includes determining, by the computing system, a light electric vehicle of the one or more light electric vehicles to provide the vehicle service along the second route segment and to accompany the autonomous vehicle along at least a portion of the first route segment. The method includes outputting, by the computing system, data associated with the service request for the autonomous vehicle.

Another example aspect of the present disclosure is directed to a computing system. The computing system includes one or more processors and one or more tangible, non-transitory, computer readable media that collectively store instructions that when executed by the one or more processors cause the computing system to perform operations. The operations include obtaining a service request for a vehicle service. The service request is indicative of an origin location and a destination location. The operations include determining a route from the origin location to the destination location. The operations include segmenting the route into a plurality of route segments. The route segments include a first route segment that is traversable by one or more autonomous vehicles and a second route segment that is traversable by one or more light electric vehicles. The operations include determining an autonomous vehicle of the one or more autonomous vehicles to provide the vehicle service along the first route segment. The operations include determining a light electric vehicle of the one or more light electric vehicles to provide the vehicle service along the second route segment and to accompany the autonomous vehicle along at least a portion of the first route segment. The operations include outputting data associated with the service request for the autonomous vehicle.

Another example aspect of the present disclosure is directed to an autonomous vehicle. The autonomous vehicle includes one or more processors and one or more memory devices, the one or more memory devices storing instructions that when executed by the one or more processors cause the one or more processors to perform operations. The operations include receiving communications corresponding to a route from an origin location to a destination location. The route includes a first route segment that is traversable by the autonomous vehicle and a second route segment that is traversable by one or more light electric vehicles. The operations include determining a light electric vehicle of the one or more light electric vehicles to provide the vehicle service along the second route segment and to accompany the autonomous vehicle along at least a portion of the first route segment. The light electric vehicle is determined at least in part based on a proximity of the light electric vehicle to a point along an initial route to the origin location or to a point along the first route segment.

Other example aspects of the present disclosure are directed to systems, methods, vehicles, apparatuses, tangible, non-transitory computer-readable media, and memory devices for controlling autonomous vehicle and providing and/or coordinating a multi-modal vehicle service.

The technology described herein can help improve the experience of a rider and/or operator of a vehicle service and decrease associated costs (e.g., to the rider or to the operator), as well as provide other improvements as described herein. Moreover, by effectively coordinating the provision of vehicle services across different modes of transportation, the technology of the present disclosure can help improve the ability of an autonomous vehicle and/or light electric vehicle to effectively provide vehicle services to others and support various members of the community in which the vehicles are operating, including persons with reduced mobility and/or persons that are underserved by other transportation options. Additionally, the technologies of the present disclosure may reduce traffic congestion in communities as well as provide alternate forms of transportation, which may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which references the appended figures, in which:

FIG. 1 depicts a block diagram of an example system for controlling the navigation of an autonomous vehicle according to example embodiments of the present disclosure;

FIG. 2 depicts an example infrastructure system according to example embodiments of the present disclosure;

FIG. 3 depicts example types of vehicles and vehicle service providers according to example embodiments of the present disclosure;

FIGS. 4A-D depict an example embodiment in which an AV may carry an LEV.

FIG. 5 depicts an example geographic area(s) with a segmented vehicle service route according to example embodiments of the present disclosure;

FIG. 6 depicts a flow diagram of an example method for performing allocation of vehicle service assignments according to example embodiments of the present disclosure;

FIG. 7 depicts example units associated with a computing system for performing operations and functions according to example embodiments of the present disclosure; and

FIG. 8 depicts a block diagram of an example computing system according to example embodiments of the present disclosure.

### DETAILED DESCRIPTION

Example aspects of the present disclosure are directed to systems and methods of providing a multimodal vehicle service using autonomous vehicles (AVs) and, optionally, light electric vehicles (LEVs). In particular, the systems and methods of the present disclosure provide for segmenting a route for providing a vehicle service and determining an AV and an LEV for traversing one or more segment(s) of the route.

By way of example, a service entity (e.g., that operates, maintains, manages, etc. a vehicle service platform that coordinates the provision of vehicle services) can receive one or more service requests. Each service request can be associated with a vehicle service (e.g., a service to transport a person from an origin to a destination). In general, the service entity can determine a vehicle service route from an origin location corresponding to the service request(s) to a requested destination location. The route may be determined for the vehicles to follow in order to transport a person from the origin location to the destination location. In some examples, different vehicles may be desired to traverse different portions of the route.

For example, the service entity can segment the route into route segments. It may be desired for the vehicle service to transport a person in an AV along a first route segment, while the person traverses a second route segment using an LEV. The service entity can determine a number of vehicles (e.g., AVs and/or LEVs) to provide the vehicle service based on one or more vehicle factors (e.g., operational/autonomy capabilities, location, fuel/energy level, environmental/weather considerations, etc.). In some implementations, the service entity can also, or alternatively, consider one or more convenience factors (e.g., time, service price, etc.). In addition, the service entity can determine one or more transfer locations based at least in part on the number of vehicles and one or more locations associated with the service request. The transfer locations can be areas where a person travelling with the vehicle service can transfer from one vehicle to another. For example, after traversing a segment of the vehicle service route in an AV, the person can transfer to an LEV at a transfer location for traversing another segment of the vehicle service. The service entity can determine a vehicle service route from an origin location to a destination location that includes the one or more transfer location(s) such that the route is divided into segments in accordance with the transfer locations.

In some examples, the service entity can determine (e.g., select, identify, locate, etc.) an AV to service at least one route segment based at least in part on the vehicle's autonomous operational capabilities (e.g., ability to turn left, U-turn etc.), so that, for example, the AV can reliably complete its portion of the vehicle service route and allow the person to switch vehicles at a transfer location for traversing one or more additional portion(s) of the vehicle service route. Additionally, in some examples, the service entity may determine (e.g., select, identify, locate, etc.) an LEV to service at least one other route segment based at least in part on the LEV's operational capabilities, the availability of route(s) accessible to the LEV, and/or the efficiency of using the LEV to provide the vehicle service in conjunction with the AV. In some examples, the AV may carry the LEV along at least a portion of the vehicle service route so that a person travelling with the vehicle service may easily and quickly transfer from the AV to the LEV at a transfer location. The service entity can further organize and/or coordinate the process of uniting the AV and the LEV for a particular service request. For instance, the service entity can leverage incentives (e.g., rewards) to secure assistance in uniting the AV and LEV (e.g., by users retrieving an LEV and loading it onto/into the AV).

In this manner, the technology of the present disclosure expands the service entity's ability to provide vehicle services, while also improving the efficiency of the AV's autonomous route navigation so that the AV can navigate without wasting the vehicle's onboard resources (e.g., energy, processing, memory, etc.) on maneuvers that the vehicle may have difficulty completing. Additionally, embodiments of the technology of the present disclosure provide for the determination and efficient selection of a particular LEV to optimally service a portion of a vehicle service route in conjunction with a particular AV, which can reduce the energy expended by the AV and/or the LEV in providing the vehicle service.

An AV can include various systems and devices configured to control the operation of the vehicle. For example, an AV can include an onboard vehicle computing system (e.g., located on or within the AV) that is configured to operate the AV. Generally, the vehicle computing system can obtain sensor data from a sensor system onboard the vehicle, attempt to comprehend the vehicle's surrounding environment by performing various processing techniques on the sensor data, and generate an appropriate motion plan through the vehicle's surrounding environment.

An LEV can include a scooter, moped, electrically assisted bicycle or “e-bike,” personal transportation device, personal mobility aids, etc. The LEV may include, in some examples, an onboard vehicle computing system (e.g., located on or within the LEV) that is configured to record and/or transmit data, such as data describing a status of the LEV, identifying the LEV, and/or locating the LEV. In some examples, the LEV may be manually controlled by a person driving the LEV, although the LEV may include partial and/or complete autonomy capabilities. For instance, the onboard vehicle computing system may interface with a person driving the LEV to provide and/or receive information corresponding to a vehicle service route.

The vehicle computing system of the AV and/or the LEV can communicate with a remote computing system such as, for example, an operations computing system and/or a one or more remote devices via a communication system onboard the vehicle. The operations computing system can be associated with a service entity that provides one or more vehicle services.

As described in greater detail herein, in some implementations, the operations computing system can include various sub-systems/back-ends that are configured to perform various functions. For example, the operations computing system (e.g., a matching/deployment system back-end) can be configured to receive a service request for a vehicle service. The operations computing system (e.g., a routing system back-end) can be configured to determine a vehicle service route based on the service request. In addition, the operations computing system (e.g., the matching/deployment system back-end) can be configured to identify a plurality of candidate vehicles available to perform at least a portion of the vehicle route. As further described herein, the operations computing system can be configured to segment the vehicle route for servicing by one or more different vehicle types (e.g., an AV and an LEV). In one example, the segmentation may be based on one or more operational capabilities associated with each candidate vehicle, although the segmentation may be additionally or alternatively based on other factors, such as environmental, regulatory, safety, and/or convenience factors. The operations computing system can be further configured to determine one or more candidate vehicles, including one or more candidate vehicles of different vehicle types, for providing the vehicle service along each segment of the vehicle service route. The operations computing system can communicate data indicative of the service request for the candidate vehicles (e.g., directly and/or indirectly to the vehicles, etc.). In this manner, the operations computing system can be configured to facilitate a transportation service utilizing multiple vehicles, where appropriate.

More particularly, the operations computing system can receive a service request for a vehicle service. The vehicle service can be associated with a user. For example, the operations computing system (e.g., the matching/deployment system back-end) can receive a service request for a vehicle service associated with a user of a service entity. In some implementations, the operations computing system can receive the service request from the user via a user device. In some implementations, the operations computing system can receive data indicative of the service request from another system (e.g., associated with the service entity, associated with a third party, etc.). The service request can include data indicative of a start location and an end location. For example, the service request can be associated with a transportation service for a person or a plurality of persons from the start location (e.g., a requested origin, a future location of the user and/or a person who will travel with the vehicle service, etc.) to the end location (e.g., a requested destination, etc.). The service request can include a start location and/or an end location indicative of a geographic location. The geographic location can include, for example, one or more geographic coordinates, reference landmarks, global positioning data, etc.

The service request can include one or more preferences (e.g., size and/or number of vehicles, price, time, etc.). By way of example, the user associated with the service request can specify one or user preferences for the vehicle service. In addition, or alternatively, the user can be associated with a user profile indicative of one or more user preferences. For example, in some implementations, a user of service entity can create a user profile for the service entity. The user profile can indicate one or more user preferences for future service requests from the user. The person(s) travelling with (e.g., transported by) the vehicle service may be user(s) of the service entity, although it is contemplated that a user of the service entity may be associated with a service request for transporting one or more persons that are not the user. In addition, or alternatively, the service request can be associated with a transportation service for one or more items (e.g., items/products for personal delivery, bulk items for business, freight transportation, baggage, other payloads, etc.) from the start location to the end location.

The operations computing system (e.g., the routing system back-end) can determine vehicles which may be utilized for servicing the service request. This can include vehicles that are online with the service entity and available to perform a vehicle service, as further described herein. In some implementations, the vehicles can include vehicles of the service entity (“first party vehicles” or “service entity vehicles”). In some implementations, the vehicles can be vehicles of a vehicle provider (“third party vehicles”). A vehicle provider can be, for example, a third-party vehicle vendor, operator, manager, etc. that owns, operates, manages, etc. a fleet of third-party vehicles. The vehicle provider can make its fleet (or a portion of its fleet) of third-party vehicles available to the service entity such that the third-party vehicles are available for performing vehicle services (e.g., to address a service request). Each of the one or more vehicle providers can be associated with one or more fleets of vehicles. Thus, each respective vehicle in the plurality of vehicles can be associated with at least one of the one or more fleets of vehicles associated with the one or more vehicle providers.

Each vehicle can be associated with a particular fleet of vehicles based on one or more shared attributes such as, for example, a manufacturer of the vehicle (e.g., make, model, etc.); a type of the vehicle (based on size, fuel/energy efficiency, seating and/or luggage capacity, etc.); a vehicle provider; and/or other factors sufficient to separate or otherwise distinguish the plurality of vehicles. For example, in some implementations, each fleet of vehicles can be associated with one or more operational capabilities. In some implementations, the operational capabilities of each vehicle in a respective fleet of vehicles can correspond to a set of operational capabilities associated with the respective fleet of vehicles. As further described herein, the operational capabilities of a vehicle and/or a fleet can indicate the capabilities (e.g., autonomy capabilities, etc.) the vehicle/fleet is able to perform, the capabilities the vehicle/fleet are unable to perform, areas in which the vehicle/fleet are able and/or permitted to operate, areas in which the vehicle/fleet are unable and/or restricted from operating, etc.

Operational capabilities can include, for example, one or more driving capabilities and/or one or more area permissions. The one or more driving capabilities, for example, can correspond to a type of vehicle (e.g., an AV, an LEV). In addition, an operational capability can be a feature, function, and/or behavior of the vehicle. In some examples, a vehicle's operational capabilities may be incompatible with one or more requirements or other characteristics of a vehicle service desired for servicing a vehicle service request.

For example, one or more driving capabilities can be indicative of one or more restricted driving maneuvers an AV is unable to perform and/or one or more autonomous driving maneuvers that the AV is able to perform. This can include, for instance, the ability (or inability) of the AV to complete a U-turn, unprotected left turn, and/or other capabilities of the AV. The operational capabilities can include, for example, speed limits and directions (e.g., conformity to specified speed limits, directions of travel, lane restrictions, etc.); stop and go traffic (e.g., ability to properly handle dense traffic conditions with frequent slow-downs, starts, stops, etc.); turning (e.g., ability to handle left hand turns, unprotected turns, three point turns, U-turns, etc.); parking (e.g., parallel parking, required parking space dimensions, etc.); navigating certain geographic features (e.g., crossing train tracks); traveling in reverse (e.g., backing into a parking space); signaling (e.g., handling turn signal(s) from other objects); nudging; handling jaywalkers; speed and/or ease of ingress/egress (e.g., for transferring from the AV to an LEV); and/or other capabilities of the AV. In some implementations, an AV capability can depend on another AV capability. For example, the AV's ability to handle stop-and-go traffic can depend on its ability to handle speed limits and direction.

Additionally, or alternatively, one or more driving capabilities may be indicative of one or more features and/or limitations of an LEV. In some examples, the limitations may correspond to functional and/or safety limitations. This can include, for example, top speed and/or acceleration (e.g., for safe integration and/or interaction with traffic, such as for merging maneuvers, crossing lanes, etc.); ability to trigger stoplights at intersections; range; terrain capabilities (e.g., for safely ascending/descending steep gradients; handling rough terrain, such as at some railroad crossings; and/or traversing standing/running water); illumination capabilities (e.g., for safely illuminating potentially unlit pathways and/or roads, for maintaining optimal visibility in adverse weather, etc.); and/or other capabilities of an LEV.

The operational capabilities can be included in a pre-defined group (e.g., list, table, etc.) of vehicle capabilities. For instance, the one or more capabilities can be indicative of a list of capabilities. Each list of capabilities can include one or more maneuvers that the vehicle can safely perform. In some implementations, the absence of a vehicle maneuver from the list of capabilities can be indicative of a restriction. For example, in some implementations, the list of capabilities can be an exhaustive list of driving maneuvers that can be safely performed by a respective vehicle.

In addition, or alternatively, each of the one or more area permissions can be indicative of one or more geographic areas in which a vehicle (e.g., AV, LEV, etc.) and/or a vehicle type is permitted to travel and/or is capable of traveling. For instance, the one or more area permissions can be indicative of AV capabilities such as operating conditions, routes, and/or the like where one or more AV can safely operate. Similarly, the one or more area permissions may be indicative of LEV capabilities, such as access to specific lanes and/or pathways (e.g., bike lanes and/or multi-use trails). In some examples, the one or more area permissions may indicate one or more routes or route segments accessible by an LEV but not an AV (e.g., bike lanes and/or multi-use trails that prohibit AVs), indicating an incompatibility between the AV and the one or more routes or route segments. Other area permissions may include regulatory information and/or restrictions corresponding to local or regional ordinances regarding the operation of an AV and/or LEV in an area (e.g., an ordinance limitation). In some implementations, the one or more area permissions can be indicative of one or more geographic regions that the AV is mapped to travel within (e.g., a mapping limitation). In some implementations, if an AV does not have access to mapping data describing a geographic region, the AV may not be associated with area permissions for operating within the geographic region.

In general, however, an incompatibility between a vehicle and one or more routes or route segments may include any discrepancy between one or more operational capabilities and the requirements of the one or more routes or route segments and/or convenience factors associated with the service request. In some examples, a first type of vehicle may be used along a certain regularly-scheduled route (e.g., an AV designated to traverse a regular and/or predetermined route). Thus, vehicle service requests which overlap and/or coincide with at least a portion of the regularly-scheduled route may be serviced at least in part by a vehicle of the first type of vehicle. The respectively designated AVs may be incompatible with additional vehicle service route segments which diverge from the predetermined route(s) (e.g., a vehicle service route limitation), at least with respect to vehicle service requests which are to be serviced while the AVs are so designated.

To help provide a vehicle service, the operations computing system can determine a vehicle service route from the start location to the end location. For instance, the operations computing system can access map data indicative of the start location and the end location. The operations computing system can determine the vehicle service route based at least in part on the map data. The map data may include, in some examples, data corresponding to one or more operational capabilities of the vehicles which may be utilized for servicing the service request. For example, the map data may indicate one or more area permissions corresponding to one or more types of vehicles.

The operations computing system can differentiate between one or more vehicles based on their capabilities (e.g., driving capabilities, area permissions, etc.) to segment a vehicle service route into segments traversable by different types of the one or more vehicles. For example, the operations computing system can segment a vehicle service route to include at least one segment traversable by one type of vehicle (e.g., one or more AVs) and another segment traversable by another type of vehicle (e.g., one or more LEVs). This, in turn, can allow the operations computing system to leverage different types of vehicles to service a wide geographic area and/or a diverse base of users. For example, some vehicles can be configured to perform better when providing different types of services such as urban transportation, interstate transportation, transportation to airports, etc. By way of example, in some implementations, the operations computing system can pool together multiple service requests into a single segmented route that utilizes multiple urban vehicles configured to pool passengers to a joint interstate transportation vehicle (e.g., a more efficient, comfortable, and/or higher passenger capacity vehicle, etc.). Furthermore, an LEV may offer advantages in some service areas and/or along some portions of a vehicle service route, such as where an LEV may have access to additional or alternative routes, lanes, or pathways not accessible to an AV. For instance, an LEV may be able to bypass particular areas of traffic and/or delays along a vehicle service route (e.g., based on historical and/or current data indicative of traffic speed and/or congestion). Additionally, or alternatively, an LEV may be able to shorten a vehicle service route by leveraging routes accessible to the LEV but not the AV. For example, an LEV may cut across a city center area and/or park area by travelling on a multi-use trail (e.g., a bike path or lane), whereas, in some cases, an AV may be limited to traveling around the area. Thus, by segmenting a vehicle route based on the operational capabilities of a plurality of candidate vehicles, the operations computing system can effectively utilize the computing resources and transit resources made available by a fleet of vehicles rather than focusing on one vehicle to service an entire route.

In some implementations, the operations computing system can segment the vehicle route into one or more route segments based at least in part on one or more convenience factors associated with the service request. The one or more convenience factors, for example, can include one or more criteria that effect the desirability of choosing a travel route such as, for example, a price, a number of transfer locations, a time, a duration of travel, and/or a type of vehicle. The operations computing system can determine the number of vehicles and/or the number of route segments for a service request based at least in part on the one or more convenience factors. For example, the price charged for a vehicle service request can depend on the number of AVs and/or LEVs that service the vehicle service request. By way of example, in some scenarios, an LEV may be cheaper than an AV (e.g., due to lower running, maintenance, and/or insurance/liability costs). In other scenarios, an LEV may be more expensive than, for example, a vehicle service provided in by an AV servicing a plurality of pooled service requests. In some examples, segmenting a vehicle service route to be jointly serviced by an AV and an LEV may decrease the travel time and/or service price for the person travelling with the vehicle service, such as by avoiding traffic and/or shortening the vehicle service route.

In some examples, an AV may be capable of completing an entire route, but it may be undesirable (e.g., for the person travelling, for the vehicle, for the provision and/or coordination of other vehicle services, etc.) for the AV to travel from its current location to the starting location of the route (e.g., due to traffic, distance, time, etc.). Thus, segmenting a vehicle route into two route segments serviceable by two vehicles can be a cost and/or time effective option for the user. For example, the operations computing system can provide a user with an option for the vehicle service provided with one vehicle (e.g., an AV) and an option for the vehicle service provided with at least one route segment to be traversed by another vehicle (e.g., an LEV). In this way, the operations computing system can determine a number of vehicles over the bare minimum of vehicles (e.g., based on operational capabilities) to traverse a vehicle route based on convenience factors. For example, the operations computing system can determine that two or more vehicles may be used to fulfill a service request where one or more operational constraints prevent a single vehicle from fulfilling the service request. In other cases, for example, where one vehicle (e.g., an AV) can fulfill the service request based on its operational capabilities, the operations computing system can nonetheless determine that two or more vehicles may be advantageous (e.g., to reduce cost, travel time, etc.).

In some implementations, the operations computing system can determine one or more ancillary vehicle service routes for the vehicle route. Each ancillary vehicle service route can include a route from the start location to the end location based at least in part on a number of vehicles and/or segments associated with the ancillary vehicle service route. For example, the operations computing system can determine the one or more ancillary vehicle service routes based at least in part on the vehicle service route, the number of vehicles for the service request, the one or more operational capabilities associated with each vehicle in the plurality of candidate vehicles and/or the one or more convenience factors associated with the service request. In some implementations, each ancillary vehicle service route can be associated with a different number of vehicles and/or a different number of segments. By way of example, the operations computing system can determine an ancillary vehicle service route for every combination of vehicles capable (e.g., based on operational capabilities, safety factors, convenience factors, etc.) of completing the vehicle service requests. In this manner, the operations computing system can provide a user with one or more options for completing the service request (e.g., by generating a query for the user). For example, each ancillary vehicle service route can include one or more convenience factors, such as time, price, etc. In some implementations, the operations computing system can allow a user to select a number of vehicles and/or route segments based on the one or more convenience factors associated with the corresponding ancillary vehicle service route via a user interface of a service application running on the user's mobile device.

The operations computing system can determine one or more transfer locations for the vehicle service route and/or one or more ancillary vehicle service routes. For example, the operations computing system can determine one or more transfer locations for a segmented route (e.g., vehicle service route, ancillary vehicle service route, etc.). By way of example, a transfer location can allow a person travelling with the vehicle service and/or a transported item to transfer from one vehicle to another. For example, the transfer may include transferring from one vehicle used to traverse a first route segment (e.g., an AV) to another, different vehicle for traversing a second route segment (e.g., an LEV). Thus, each transfer location in the one or more transfer locations can be associated with at least two vehicles in so far as each transfer location can be proximate to an area reachable by each of the at least two vehicles.

The transfer location(s) for a vehicle service can be determined based at least in part on the start location and the end location associated with the service request. In some implementations, the operations computing system can determine one or more candidate locations in between and/or proximate to the start location and/or the end location. The operations computing system can determine the transfer location(s) from the candidate location(s). For example, the operations computing system can obtain information regarding candidate locations in a geographic area that includes the start location and/or end location (e.g., from a location database). The operations computing system can determine transfer location(s) from the candidate location(s) by filtering the candidate location(s) based on one or more convenience factors and/or one or more operational capabilities.

By way of example, the operations computing system can determine the one or more transfer locations for a route (e.g., vehicle service route, ancillary vehicle service route, etc.) based on the one or more operational capabilities associated with each candidate vehicle in the plurality of candidate vehicles. For example, when the operations computing system segments a vehicle service route into at least two route segments, and determines a vehicle of one type (e.g., an AV) to traverse one route segment and a vehicle of another type (e.g., an LEV) to traverse another adjacent route segment (e.g., an immediately subsequent route segment), a transfer location may be determined in an area accessible by both types of vehicles. For example, the operations computing system can filter the candidate locations based on the number of vehicles available to service the candidate location due to operational capabilities (e.g., driving capabilities and/or area permissions). By way of example, a candidate location in a particular urban area may be serviceable by a subset of the plurality of candidate vehicles (e.g., AVs mapped to/allowed in the particular urban area, LEVs which meet certain criteria under local ordinances, etc.), whereas a candidate location located off the interstate may be serviceable by a different subset of the plurality of candidate vehicles which may be the same or different (e.g., AVs mapped to nearby routes, LEVs suited to traveling on the roads to/from the transfer location, etc.).

In some examples, a transfer location may be determined to correspond to a change in one or more area permissions and/or a limit of one or more operational capabilities of a vehicle providing the vehicle service. For example, the operations computing system can determine the one or more transfer locations for a vehicle service route to correspond to (e.g., coincident with or nearby) a boundary of a mapped area for the AV providing the vehicle service along a portion of the vehicle service route (e.g., a route segment). A person travelling with the vehicle service may then transfer from the AV to, for example, an LEV at the transfer location, and the person may continue travelling along a subsequent route segment on the LEV. In some implementations, the one or more transfer locations may be determined based at least in part on an accessibility of the destination location or subsequent transfer locations by an LEV (e.g., when traversing at least one subsequent route segment). For example, when an LEV is determined to provide the vehicle service along a final route segment of the vehicle service route, the transfer location between the final route segment and the preceding route segment may be determined based at least in part on the ability of the LEV to reach the destination location from the transfer location (e.g., a sufficient range and/or charge in the LEV, terrain and/or traffic within the capabilities of the LEV, etc.).

A transfer location between two route segments may also be determined based at least in part on a relative speed of travel between the vehicle determined for traversing one route segment (e.g., an AV) and the vehicle determined for traversing the next (e.g., and LEV). For example, an AV may traverse a route segment comprising highway or other road sections which have traffic that moves at relatively high speeds. However, in dense urban areas, traffic speed may slow such that an LEV may move faster than traffic speed along bike lanes and/or other trails which are not accessible by the AV. In one embodiment, the operations computing system may segment the vehicle service route to capitalize on the advantages of the LEV (e.g., access to bike lanes, bypassing traffic) to improve the quality of the vehicle service (e.g., lowering transit times for a person travelling with the vehicle service), decrease traffic congestion in the urban areas, decrease the energy consumed by the AV, and/or decrease the computational cost for the AV by avoiding navigating dense urban areas using the onboard autonomous computing systems. A transfer location may be determined at a location along the vehicle service route (e.g., the vehicle service route may be determined to pass through or nearby a desired transfer location) to correspond to the segmentation of the vehicle service route.

In addition, or alternatively, the operations computing system can determine the one or more transfer locations for a route (e.g., vehicle service route, ancillary vehicle service route, etc.) based on one or more convenience factors associated with the service request. For example, the operations computing system can filter the candidate locations by convenience factors (e.g., such as ease of access, amenities such as reserved parking or staging areas, weather shelter, detour distance, time value, vehicle availability, etc.) and/or safety factors (e.g., speed of nearby traffic, number of incident reports, illumination, etc.).

In some examples, a transfer location and/or convenience or safety factors associated therewith can be determined based on user input. For example, a user may input a desired transfer location. A user may input a desired transfer location by, for example, selecting a transfer location from a list of candidate transfer locations. Additionally, or alternatively, the user may select or otherwise indicate an area of a map displayed in a user interface, and the operations computing system may prioritize or otherwise determine the one or more transfer locations based on a proximity to or location within the indicated map area.

In some implementations, the operations computing system can score the candidate location(s) based on one or more operational capabilities of one or more vehicles and one or more convenience factors associated with the service request. The operations computing system can determine the transfer location(s) from the candidate location(s) based at least in part on the score. As an example, a candidate location nearby well-maintained existing infrastructure (e.g., roads, wireless coverage, etc.) can be scored higher than a remote candidate location with poor access. As another example, a candidate location with fewer incident reports (e.g., police reports, insurance claims, etc.) than other candidate locations can be scored higher than the other candidate locations. As another example, a candidate location with more amenities or higher-valued amenities than other candidate locations can be scored higher than the other candidate locations. As another example, a candidate location having a shorter detour distance than other candidate locations with respect to a route for the vehicle service can be scored higher than the other candidate location(s). As another example, if a route that includes a candidate location is associated with a shorter completion time than a route that does not include the candidate location (a positive time value), then the candidate location can be scored higher than other candidate locations. Conversely, in the event a route that includes a candidate location is associated with a longer completion time than a route that does not include the candidate location (a negative time value), then the candidate location can be scored lower than other candidate locations.

In some implementations, the transfer location can be associated with a plurality of service requests. For example, in some implementations, the operations computing system can determine a common transfer location for a route (e.g., vehicle service route, ancillary vehicle service route, etc.) such that it coincides with an arrival of a plurality of persons travelling with the vehicle service at the common transfer location. By way of example, the operations computing system can receive a plurality of separate service requests for a vehicle service from a plurality of users. The operations computing system can determine a plurality of routes (e.g., vehicle service route, ancillary vehicle service route, etc.) based on the plurality of service requests. For example, the operations computing system can determine at least one route (e.g., vehicle service route, ancillary vehicle service route, etc.) for each service request in the plurality of service requests. The operations computing system can determine one or more candidate locations for each route (e.g., vehicle service route, ancillary vehicle service route, etc.) in the plurality of routes. In some implementations, the operations computing system can determine a candidate location common to one or more routes (e.g., vehicle service route, ancillary vehicle service route, etc.) in the plurality of routes. The operations computing system can determine a common transfer location for each of the one or more routes (e.g., vehicle service route, ancillary vehicle service route, etc.) based on the candidate location common to the one or more routes. In this manner, the operations computing system can determine a common transfer location for a plurality of service requests that share a portion of a route (e.g., vehicle service route, ancillary vehicle service route, etc.). In one embodiment, the plurality of service requests which correspond to a shared portion of a route may simultaneously be serviced by the same vehicle traveling along the shared portion of the route (e.g., passengers respectively corresponding to the plurality of service requests riding in the same AV), while one or more of the plurality of service requests may be serviced by transferring to a plurality of different vehicles for providing the vehicle service along subsequent, unshared portions of the route (e.g., the passengers respectively corresponding to the plurality of service requests transferring to different LEVs for transit to their respective destinations).

Additionally, or alternatively, a transfer location may be determined to coordinate availability of vehicles for a plurality of service requests. For example, a first service request may correspond to a first route (e.g., vehicle service route, ancillary vehicle service route, etc.) which intersects with a second route (e.g., vehicle service route, ancillary vehicle service route, etc.) corresponding to a second service request. The first service request may include a first AV route segment followed by a first LEV route segment, and the second service request may include a second LEV route segment followed by a second AV route segment. In some examples, a transfer location may be determined such that the first AV route segment, first LEV route segment, second LEV route segment, and second AV route segment intersect, meet, and/or coincide at the transfer location. In this manner the AV used to service the first AV route segment may service the second AV route segment, and the LEV used to service the second LEV route segment may service the first LEV route segment.

In some implementations, the operations computing system can segment the route (e.g., vehicle service route, the one or more ancillary vehicle service routes, etc.) into one or more route segments based at least in part on the one or more transfer locations. Each route segment can be serviceable by at least one candidate vehicle in the plurality of candidate vehicles. Thus, the operations computing system can segment the route (e.g., vehicle service route, the one or more ancillary vehicle service routes, etc.) such that the number of segments match the number of vehicles determined for the route (e.g., vehicle service route, the one or more ancillary vehicle service routes, etc.). By way of example, each route segment can include a segment start location and a segment end location. The segment start and segment end location can include a transfer location and/or the start or the end location associated in the service request.

When a particular route segment is traversable by one or more vehicles (e.g., one or more AVs in a fleet, one or more LEVs in a fleet), the operations computing system can determine a vehicle of the one or more vehicles to provide a vehicle service along the particular route segment. In some implementations, the operations computing system can determine an AV (e.g., of one or more AVs, such as AVs in a fleet available for servicing a service request) and/or LEV based on the segmentation of the vehicle service route. For instance, the endpoints of a route segment (e.g., a start location and/or end location of the segment) may be used in the determination of a vehicle to service the particular route segment (e.g., based on the relative proximity of the vehicle to the endpoint as compared to others of the one or more vehicles, the travel time between the vehicle and the endpoint, etc.). In some implementations, the determination of a vehicle of one or more vehicles to service the particular route segment may provide at least a partial basis for one or more ancillary vehicle routes, which may be determined and/or segmented based at least in part on the individual characteristics of the particular vehicle of the one or more vehicles (e.g., location, fuel/energy capacity, fuel/energy efficiency, fuel/energy status or amount, seating capacity, maintenance status, etc.).

In some implementations, a vehicle service route can include a first route segment traversable by one or more AVs and a second route segment traversable by one or more LEVs. The operations computing system can determine an AV to service the first segment based on the ability of the AV to convey an LEV to a transfer location for transferring between the first route segment and the second route segment. In this manner, the person travelling with the vehicle service may quickly and easily transfer from the AV to the LEV at the transfer location without concern about securing an LEV upon arrival. For example, the AV may include sufficient cargo capacity to carry one or more LEVs (e.g., in a cargo space or otherwise secure in/on the AV). In some examples, the AV may be configured to carry one or more LEVs in a collapsed state (e.g., a folding bike and/or scooter in a folded state).

In some examples, the AV may be configured initiate a charging action to provide power (e.g., an electric charge, etc.) to one or more LEVs while carrying the LEV(s). The AV may optionally charge the LEV(s) with a wired or wireless charging configuration (e.g., via a mating receptacle, cooperative inductive charging components, etc.) from an energy source onboard the AV (e.g., batteries, generators, regenerative energy harvesters, solar power units, etc.). In some examples, an AV may be configured to carry a plurality of types of LEV (e.g., a scooter, moped, electrically assisted bicycle or “e-bike,” personal transportation device, personal mobility aids, etc.) which may be charged by the AV. For instance, a plurality of LEV types may be configured to use a compatible energy source packaging (e.g., power pack, batteries, etc.) such that the energy source from any of a plurality of LEVs may be charged by the AV (e.g., in an energy source charging receptacle of the AV). The AV may comprise an onboard computing system for monitoring the charge level(s) of one or more LEVs carried by the AV. The AV may thereby estimate and/or predict a future charge level of the one or more LEVs. For example, an AV conveying an LEV to a transfer location may be configured to predict the charge level of the one or more LEVs upon arrival at the transfer location. Additionally, or alternatively, the operations computing system may estimate and/or predict a future charge level of one or more LEVs carried (or determined to be carried) by the AV.

The operations computing system can determine an LEV of one or more LEVs operable to traverse the second route segment. For example, a plurality of LEVs may have the desired operational capabilities for traversing the second route segment in view of any desired convenience factors. The operations computing system may determine an LEV among such plurality of LEVs to most efficiently provide the vehicle service. Efficiently providing the vehicle service may correspond, for example, to an efficient use of an energy source of an LEV determined to provide the vehicle service along the second route segment. For example, the operations computing system may determine the LEV based at least in part on a proximity of the LEV to the location of an AV determined to provide the vehicle service along another segment of the vehicle service route (e.g., the AV determined to provide the service along the first route segment). For instance, an AV may be carrying an LEV, and the operations computing system can select the AV carrying the LEV to provide a vehicle service along a first route segment and select the LEV carried by the AV to provide the vehicle service along a second route segment. In this manner, the LEV is selected based at least in part on the proximity (e.g., a coincidence) to the AV. Moreover, the LEV does not need to consume any energy (e.g., computational resources, driving resources, etc.) to be united with the AV to provide the vehicle service.

In some examples, the operations computing system may determine the LEV based at least in part on a proximity of a location of the LEV to a different location of an AV. For example, one or more LEVs may be external to the AV determined to provide a vehicle service along the first route segment. An LEV may be selected to decrease and/or minimize the distance between the determined LEV and the AV. The distance to be decreased and/or minimized includes a straight-line distance and/or a distance according to a travel route (e.g., roadway, pathway, etc.) between the LEV and the AV.

In some implementations, the operations computing system may determine the LEV based at least in part on a proximity of a location of the LEV to a future location of an AV. For example, an AV may be selected to provide a vehicle service along a first route segment having a start location and an end location. The AV may also be determined to travel an initial route to arrive at the start location of the first route segment. Additionally, the operations computing system may determine ancillary routes (e.g., ancillary first route segment(s) and/or ancillary initial routes). Any of the routes for the AV (e.g., the vehicle service route, the first route segment, the ancillary routes) may correspond to future locations of the AV. For example, a route determined for the AV to travel (e.g., an initial route traveled by the AV) from among the routes may correspond to a plurality of future locations along the route. Correspondingly, the locations of one or more LEVs may be compared with the plurality of future locations of the AV to determine an LEV based at least in part on a proximity to a future location of the AV (e.g., a point along the initial route, a point along the first route segment, etc.). In this manner, any energy consumed by either the AV and/or the LEV to unite at or near the future location may be decreased and/or minimized.

In some implementations, the operations computing system may determine the LEV based at least in part on a proximity of a future location of the LEV to a present and/or future location of an AV. For example, the location of an LEV may be changing and/or projected to change. For instance, the LEV may change location as it provides a vehicle service. Additionally, or alternatively, the LEV may change location as it is carried by another vehicle (e.g., an AV carrying one or more LEVs). In this manner, one or more LEVs may correspond to one or more future locations. As discussed above, an AV may also correspond to one or more future locations. Correspondingly, the present and/or future locations of the one or more LEVs may be compared with the present and/or future locations of the AV to determine an LEV based at least in part on a proximity of a future location of the LEV to a present and/or future location of an AV. In this manner, any energy consumed by either the AV and/or the LEV to unite may be decreased and/or minimized.

The operations computing system can also determine a method for uniting the AV and LEV determined to provide a vehicle service in some embodiments. For example, the operations computing system can determine a method for uniting the AV and LEV so that the LEV accompanies the AV for at least a portion of the first route segment. In some implementations, the initial route and/or the first route segment may be determined so that the AV passes by the LEV (e.g., by including a deviation from the route to pass by the LEV and/or by determining an LEV corresponding to a present and/or future location along the initial route and/or the first route segment). In some embodiments, the AV may automatically unite with the LEV, such as by using its autonomous capabilities (e.g., by the AV approaching a position adjacent to the LEV to attach the LEV to the AV and/or storing the LEV within the AV); with the assistance of the LEV (e.g., the LEV autonomously approaches the AV, such as by approaching the curb of a roadway); and/or with the assistance of an external loading station which loads the LEV onto the AV (e.g., a drive-through loading station, a loading station adjacent to or nearby a roadway, etc.). In some examples, a loading station may be staffed by personnel who collect the LEVs for loading at the loading station (e.g., collecting LEVs in the surrounding area). The LEVs may also be charged at the loading station while awaiting the loading procedure. In some embodiments, the loading station may correspond to a transfer location, where persons travelling with the vehicle service on an LEV may transfer to an AV and leave the LEV for loading into a different AV at the loading station.

In some embodiments, the AV may unite with the LEV with the assistance of a user of the vehicle service and/or persons travelling with the vehicle service. For instance, a vehicle service route may be determined which includes at least three route segments: a beginning route segment to be traversed by an LEV, a middle route segment to be traversed by an AV, and a subsequent route segment to be traversed by an LEV. In some embodiments, the LEV used to traverse the beginning route segment may be carried by the AV along the middle route segment (e.g., optionally receiving charge during transit), and the LEV may then be used to traverse the subsequent route segment. The person(s) travelling with the vehicle service may transfer the LEV into the AV at a first transfer location to travel along with the same persons on the middle route segment, and the same person(s) may also transfer the LEV out of the AV at a second transfer location for traversing the subsequent route segment.

In some implementations, if an LEV is selected such that the AV passes by a location of the LEV, the AV may slow and/or stop so that a user and/or person travelling with the vehicle service may load the LEV onto/into the AV. In some examples, the user of the vehicle service and/or persons travelling with the vehicle service may be incentivized to assist the uniting of the AV and the LEV (e.g., by loading the LEV onto/into the AV) by the provision of a reward. For instance, a reward may be determined by the operations computing system which is provided to a user of the vehicle service conditioned on the assistance of the user of the vehicle service and/or persons travelling with the vehicle service (e.g., by retrieving and/or loading the LEV onto/into the AV). In some examples, the reward may include a social and/or economic reward. For instance, the reward may be attributable to a user account associated with a service entity that coordinates the vehicle service. A user corresponding to the user account may receive the reward conditioned on the assistance of the user and/or persons travelling with the vehicle service. The reward may include a collectible item (e.g., points, badges, tokens, etc.) which the user may display on a user profile and/or exchange in a corresponding marketplace for items (e.g., customization features for a user interface for interacting with the service entity, credits for purchasing services from the service entity, upgrades for services from the service entity, etc.). In some examples, the reward may include credits for purchasing services from the service entity, upgrades for services from the service entity, and/or discounts on present and/or future services from the service entity. Additionally or alternatively, a user may receive a discount on a vehicle service if the user and/or persons travelling with the vehicle service assist in the uniting of the AV and the LEV. The reward (e.g., a discount and/or collectible item) may be offered and/or applied at any point during the vehicle service and applied during and/or after the vehicle service (e.g., to discount a current ride, future, ride, etc.)

For example, the discount may be applied after the assistance is provided. In some examples, however, the discount may be applied when the user first sends a service request. For example, as discussed above, a user may be presented with a plurality of options for the vehicle service and/or the vehicle service route. One option may include, for example, a multimodal transport option where one route segment is traversed by an AV and another route segment is traversed by an LEV. The user may be informed that the multimodal transport option includes a possible reward (e.g., a discount and/or collectible item) upon the provision of assistance, and the user may select the multimodal transport option at the discounted price. In some embodiments, the reward (e.g., a discount and/or collectible item) may be a feature which attracts the user to select the option. The reward (e.g., a discount and/or collectible item) may be preliminarily applied/awarded, but the payment may be processed at the normal rate (e.g., without any discount) if the assistance is not provided. Additionally, or alternatively, the payment may be initially processed at the normal rate, with a security hold/deposit being returned or released upon provision of the assistance.

In some examples, the user who assists the uniting of the AV and the LEV is not travelling with the vehicle service. For instance, a reward (e.g., as described above) may be offered to one or more users respectively corresponding to user accounts associated with a service entity that coordinates the vehicle service conditioned on the assistance of the user in loading an LEV onto an AV. The one or more users may be determined (e.g., by the operations computing system) based on a proximity (e.g., present or future proximity) of the one or more users to one or more LEVs and/or one or more AVs. For instance, one or more users may be in the vicinity of a transfer location along a vehicle service route. A reward may be offered to the one or more users to retrieve an LEV. After a person travelling with the vehicle service transfers at the transfer location, the user may load the LEV onto/into the AV to replenish the LEV storage of the AV. Similarly, a reward may be offered to one or more users to retrieve one or more LEVs and bring the LEV(s) to a loading station. In some embodiments, the reward may be gamified, such that users may compete to secure rewards for assisting with the uniting of AVs and LEVs.

In some implementations, a reward may be offered to users already travelling with the vehicle service on an LEV. For instance, a first user may be utilizing an LEV of the service entity for a first vehicle service (e.g., a rental transport from one location to another). The operations computing system may receive a service request and select the same LEV to provide a different second vehicle service to a different second user. A reward may be offered to the first user to redirect the vehicle service to a different destination and/or along a different route to bring the LEV to a location enabling more efficient provision of the second vehicle service. In some embodiments, the first user may be rewarded for redirecting the route traversed by the LEV to terminate at the same location as an AV for loading the LEV onto the AV. In some embodiments, the first user is provided information indicative of the reward prior to embarking on the vehicle service route. For example, the first user desiring to travel to one destination may receive a discount for electing to travel to a different (e.g., optionally nearby) destination for meeting an AV to unite the LEV with the AV.

In some embodiments, users may be incentivized to assist in the uniting of AVs and LEVs that do not immediately correspond to a particular service request. For example, an AV may have one or more unfilled locations in/on the AV for carrying an LEV. The operations computing system may determine one or more LEVs for loading onto/into the AV when it is convenient and/or expedient to do so (e.g., a high probability of securing assistance with a reward), even if the LEVs are not yet determined to correspond to a particular service request. In this manner, an AV and one or more LEV(s) may be better prepared for efficient dispatch to provide a multimodal vehicle service.

In some embodiments, the determination of an LEV may be based at least in part on data retrieved and/or gathered by the AV. For example, the operations computing system may optionally identify that a subset of one or more LEVs is in the vicinity of an AV. In some implementations, the AV may use its onboard computing systems (e.g., sensors, processors, etc.) to locate and/or evaluate one or more LEVs. By way of example, the AV may leverage sensors to determine the position and/or orientation of an LEV with a granularity (e.g., temporal and/or spatial resolution) finer than that of, for example, sensors and/or data otherwise available to the operations computing system. In some embodiments, the operations computing system may receive data from the sensors of the AV descriptive of and/or corresponding to LEV(s). In some examples, the AV may select an LEV from among the one or more LEVs (e.g., from among the subset of LEVs). For instance, the AV may select an LEV from among the one or more LEVs (e.g., from among the subset of LEVs) based at least in part on a proximity of the LEV to a point along an initial route to the origin or start location or to a point along the first route segment. In this manner, the determination of an LEV may be based at least in part on data retrieved and/or gathered by the AV.

In some embodiments, operations described above as being performed by the operations computing system may be computed in a distributive manner with one or more AVs, or may offloaded in whole or in part to one or more AVs. For instance, an AV may be configured to receive communications corresponding to a route from an origin location to a destination location. The route may have been segmented by, for example, the operations computing system, so that the route comprises a first route segment that is traversable by the AV and a second route segment that is traversable by one or more LEVs. The AV may then use its corresponding computing systems, as described above, to determine an LEV to provide the vehicle service along the second route segment and to accompany the AV along at least a portion of the first route segment. The LEV may be determined at least in part based on a proximity of the light electric vehicle to a point along an initial route to the origin location or to a point along the first route segment. In some embodiments, the computing systems corresponding to the AV may determine a charge level of the LEV sufficient to traverse the second route segment. The charge level may be a future charge level based at least in part on a charge amount to be contributed by the AV.

In some embodiments, an AV and/or an LEV may also be determined at least in part based on one or more energy parameters of the AV and/or LEV. For example, energy parameters for an AV and/or LEV may include at least one of a charge level, an energy consumption rate, an energy charging rate, and/or the like. In one example, an energy parameter corresponds to a charge level of the LEV. The charge level of the LEV may include a present and/or future charge level. For instance, a future charge level may be estimated to consider the charge expended to unite the LEV with the AV. For example, when the LEV may be driven and/or ridden to the location at which the LEV is to unite with the AV (e.g., by a user seeking to earn a reward as described above, by any other person travelling with the vehicle service, etc.), the future charge level may include an estimation of the charge expended to reach the location. The future charge level may further include any charge to be contributed by the AV were the AV to carry the LEV to a planned transfer location and/or any charge to be contributed by, e.g., a loading station. In this manner, an LEV may be determined which will possess sufficient charge (e.g., at a future time, such as the time of arrival at a transfer location) to traverse the corresponding route segment (e.g., the second route segment).

The operations computing system can provide transit data indicative of the vehicle service route, the number of vehicles for the route, the one or more segments of the vehicle service route, and/or the vehicles corresponding to each of the one or more route segments to a user. For example, the operations computing system can provide the transit data to the user via a user device (e.g., laptop, smartphone, or other computing device). For example, the transit data can include a virtual representation of the vehicle service route, an indication of one or more transfer locations and/or segments associated with the route, an indication of the one or more vehicles assigned to service the route, a price, and/or other information relevant to the service request. In some implementations, the operations computing system can, in response to receiving the service request for a vehicle service for a user, provide data indicative of the vehicle service route and one or more ancillary vehicle service routes to the user. For example, the operations computing system can provide one or more options to the user (e.g., by determining a query for submitting to a device associated with the user). Each option can include an ancillary vehicle service route and transit data corresponding to the ancillary vehicle service route. In this manner, the user can select a vehicle route based on one or more user preferences (e.g., time, price, number of transfer locations, types of vehicles used to service the route, etc.).

The operations computing system can communicate data associated with the service request for providing the vehicle service (e.g., data for an AV and/or an LEV to provide the vehicle service). Data sent for the vehicles can be sent directly to the vehicles and/or to a remote computing system that is associated with the respective vehicles and remote from the vehicles. For example, the operations computing system can communicate data indicative of a first route segment for an AV (e.g., to the AV, to an offboard system associated therewith, etc.) and data indicative of a second route segment for an LEV (e.g., to the AV, to the LEV, to an offboard system associated therewith, to a user, etc.). The data indicative of the service request can include a request and/or a command for the vehicle to service a particular segment of the route (e.g., vehicle service route, one or more ancillary vehicle service route, etc.). For example, the data indicative of the service request can include a request for a third-party vehicle (e.g., vehicles owned by a third-party service provider, etc.) to service the request. In another example, the data indicative of the route (e.g., vehicle service route, one or more ancillary vehicle service routes, etc.) can include a command for a first party vehicle operated by the service entity to service the request.

In some embodiments, data associated with the service request and/or determinations for a vehicle service corresponding thereto may be communicated to a user associated with the service request. For example, information corresponding to the vehicle service may be communicated to the user associated with the service request for display in a user interface (e.g., on a user device, smartphone, laptop, etc.). The information can include data items descriptive of one or more aspects of the vehicle service, including a map displaying the vehicle service route and/or one or more segments thereof; any ancillary vehicle service routes and/or one or more segments thereof; the current and/or estimated location(s) of an AV and/or an LEV determined for providing the vehicle service; the current and/or estimated charge level(s) of an the AV and/or the LEV; an estimated travel time for the vehicle service route, optionally including travel time(s) for one or more segments thereof; and/or identifying characteristics of the AV and/or the LEV (e.g., a description, a color, a sign, a signal, an identification number, a barcode, a QR code, a digital tag for verification over near-field communications and/or other wireless communications, etc.).

In some examples, the operations computing system can provide transit data indicative of the vehicle route, the number of vehicles for the route, and/or the one or more segments of the vehicle route to a user. For example, the operations computing system can provide the transit data to the user via user device (e.g., laptop, smartphone, or other computing device). For example, the transit data can include a virtual representation of the vehicle route, an indication of one or more transfer locations and/or segments associated with the route, an indication of the one or more vehicles assigned to service the route, a price, a time, and/or other information relevant to the service request.

In some implementations, the operations computing system can, in response to receiving the service request for a vehicle service for a user, provide data indicative of the vehicle route and one or more ancillary vehicle routes to the user. For example, the operations computing system can provide one or more options to the user. Each option can include an ancillary vehicle route and transit data corresponding to the ancillary vehicle route. For example, each option can include a virtual representation of the ancillary vehicle route and one or more convenience factors (e.g., price, number of stops/transfer locations, time, etc.) associated with the ancillary vehicle route. In this manner, the user can select a vehicle route based on one or more convenience factors associated with the ancillary route (e.g., time, price, number of transfer locations, etc.) and/or one or more user preferences for the trip.

The systems and methods described herein may provide a number of technical effects and benefits. For instance, the operations computing system can determine one or more vehicles to service each segment of a segmented route independently. The service entity can determine one or more transfer location(s) based on the operational capability associated with each vehicle travelling the respective segments of the segmented route. In this manner, AVs can be allocated service requests and route segments that are consistent with the autonomy and navigation capabilities of the vehicles. An AV can more efficiently use its onboard computing resources (e.g., processing resources, memory resources, power resources, etc.) to complete travel without attempting to undertake maneuvers that the AV may not be able to complete or may only be able to compete with considerable computational usage. As such, the AVs can avoid wasting onboard processing, memory, power, etc. trying to perform in scenarios that are inappropriate for the vehicle's given autonomy ability. Additionally, by providing a multimodal vehicle service (e.g., using an AV to service one route segment and an LEV to service another segment), the demand for AV mapping coverage is decreased to conserve storage and processing capacity on, for example, the AV, while still providing a complete vehicle service along a vehicle service route. Similarly, systems and methods as described herein enable AVs and/or LEVs to be allocated service requests to efficiently use the charge capacity of the AVs and/or LEVs and to minimize administrative overhead of organizing and/or redistributing AVs and/or LEVs to provide vehicle services.

Moreover, the service entity can be afforded increased flexibility in managing its resources by pooling vehicles to maximize vehicle productivity. For example, AVs may be allocated service requests in a more uniform area and/or along more uniform routes when the additional range and/or accessibility features of LEVs can be leveraged for one or more route segments (e.g., to lessen or solve the “last mile problem”). This can allow for a reduction in the cost associated with maintaining vehicles, providing transportation services, and potentially expanding the number of services delivered. Additionally, an interdependence among users in a single rideshare/ride hailing service can be reduced, thereby lowering a chance that a delay affecting one user will also affect other users.

Example aspects of the present disclosure can provide a number of improvements to vehicle computing technology, such as AV computing technology. For example, the system and methods provide an improved approach for efficiently operating AVs while allocating the provision of vehicle services. The computing system can receive a service request for a vehicle service. The vehicle service request can include a start location and an end location. The computing system can determine a vehicle route from the start location to the end location.

The computing system can segment the route into a plurality of route segments. The computing system can determine a first route segment that is traversable by one or more AVs and a second route segment that is traversable by one or more LEVs. The computing system can determine an AV of one or more AVs to provide the vehicle service along the first route segment. The computing system can also determine an LEV of one or more LEVs to provide the vehicle service along the second route segment and to accompany the AV along at least a portion of the first route segment. The computing system can also output data associated with the service request (e.g., for the AV). In this manner, the computing system employs a new kind of allocation system that increases the efficiency, scalability, and practicality of utilizing AVs and LEVs to provide vehicle services. For example, the computing system can save AV resources by allocating vehicles to service a portion of a vehicle route based on operational capabilities associated with the vehicles. In this manner, the computing system can accumulate and utilize newly available information such as, for example, the operational capabilities to provide a practical improvement to AV technology, thereby improving the functioning of autonomy systems in general by factoring capabilities unique to autonomy computing systems into the provision of vehicle services.

Various means can be configured to perform the methods and processes described herein. For example, a computing system can include data obtaining unit(s), route planning unit(s), segmenting unit(s), vehicle determining unit(s), data providing unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s), etc.) can be configured to obtain data representing one or more service requests. For example, each service request can be associated with a vehicle service for a user and can include a start location and an end location. In addition, in some implementations, the means (e.g., the data obtaining unit(s), etc.) can obtain vehicle data indicative of one or more operational capabilities associated with a plurality of vehicle and map data indicative of one or more geographic areas.

In addition, the means (e.g., route planning unit(s), etc.) can be configured to determine a vehicle service route from the start location to the end location associated with a service request. For example, the means (e.g., route planning unit(s), etc.) can determine the vehicle service route based on map data indicative of one or more geographic areas including the start location and the end location of the service request.

In addition, the means (e.g., segmentation unit(s), etc.) can be configured to segment the vehicle service route into a plurality of route segments. The route may be segmented such that at least one route segment is traversable by one or more AVs (e.g., in view of operational capabilities, convenience factors, etc.) to form a first route segment and at least one other route segment is traversable by one or more LEVs (e.g., in view of operational capabilities, safety factors, convenience factors, etc.) to form a second route segment. For example, the means (e.g., segmentation unit(s), etc.) can be configured to segment the vehicle service route into one or more route segments based on one or more operational capabilities associated with each AV in a plurality of AVs and/or each LEV in a plurality of LEVs. In addition, or alternatively, the means (e.g., segmentation unit(s), etc.) can be configured to segment the vehicle service route into one or more route segments based on one or more convenience factors associated with the service request. In some implementations, the means (e.g., segmentation unit(s), etc.) can be configured to determine one or more ancillary routes. Each ancillary route, for example, can include a different number of segments. The one or more ancillary routes can be generated based on the convenience factors associated with the service request.

In addition, the means (e.g., vehicle determining unit(s), etc.) can be configured to determine an AV of the one or more AVs to provide the vehicle service along the first route segment. By way of example, the means (e.g., vehicle determining unit(s), etc.) can be configured to determine that an AV is capable of servicing the first route segment of the vehicle service route. The means (e.g., vehicle determining unit(s), etc.) can also be configured to determine that an AV is capable of conveying an LEV to the start of the second route segment for providing the vehicle service along the second route segment. The means (e.g., vehicle determining unit(s), etc.) can determine a vehicle to service a particular route segment based on such a determination.

In addition, the means (e.g., vehicle determining unit(s), etc.) can be configured to determine an LEV of the one or more LEVs to provide the vehicle service along the second route segment. The LEV may further be determined to accompany an AV of the one or more AVs along at least a portion of the first route segment such that the LEV is conveyed by the AV to the start of the second route segment.

In addition, the means (e.g., data obtaining unit(s), data providing unit(s), etc.) can be configured to communicate data associated with the service request. For example, the means (e.g., data providing unit(s), etc.) can communicate data associated with a request and/or a command for one or more vehicles to service at least one segment of the vehicle service route (e.g., an AV to service a first route segment and/or an LEV to service a second route segment). In addition, or alternatively, the means (e.g., data providing unit(s), etc.) can be configured to provide transit data indicative of the service request to a user of a user device. In this manner, the means (e.g., data providing unit(s), etc.) can inform a user of one or more segments and/or candidate vehicle determined for the vehicle route. In some examples, the means (e.g., data obtaining unit(s), etc.) may also obtain data corresponding to a user input associated with one or more routes (e.g., vehicle service routes, ancillary vehicle service routes) and/or convenience factors associated therewith.

With reference now to the appended figures, example aspects of the present disclosure will be discussed in further detail.

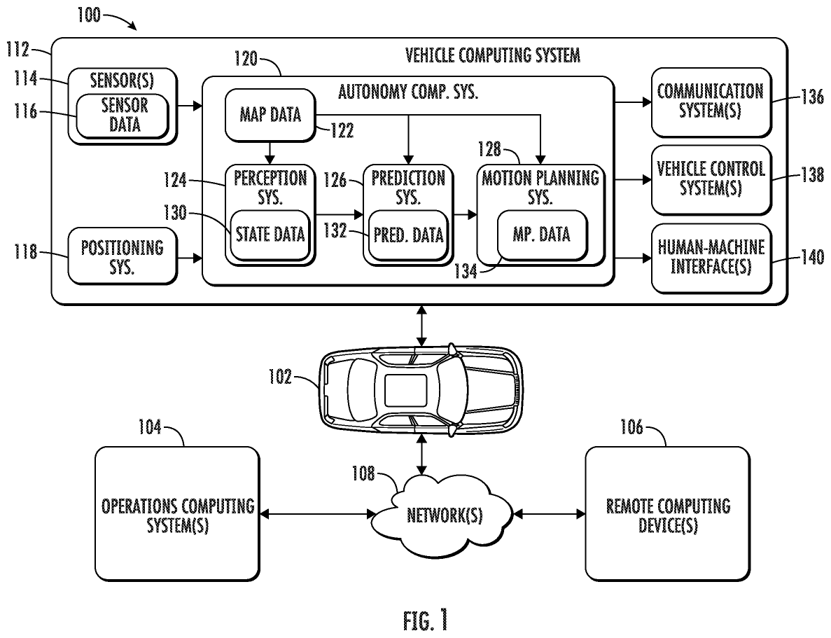

FIG. 1 depicts a block diagram of an example system 100 for controlling the navigation of an AV according to example embodiments of the present disclosure. As illustrated, FIG. 1 shows a system 100 that can include a vehicle 102; an operations computing system 104; one or more remote computing devices 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 (e.g., operations system) can be associated with a service entity that can provide one or more vehicle services to a plurality of users, passengers, riders, etc. via one or more fleets of vehicles that includes, for example, the vehicle 102. The vehicle services can include transportation services (e.g., rideshare services), courier services, delivery services, and/or other types of services.

As described in greater detail herein, the operations computing system 104 can include various sub-systems/back-ends that are configured to perform various functions. For example, the operations computing system 104 (e.g., a matching/deployment system back-end) can be configured to receive a service request for a vehicle service. The operations computing system 104 (e.g., a routing system back-end) can be configured to determine a vehicle route based on the service request. In addition, the operations computing system 104 (e.g., the matching/deployment system back-end) can be configured to identify a plurality of candidate vehicles available to perform at least a portion of the vehicle route. As further described herein, the operations computing system 104 can be configured to segment the vehicle route based on one or more operational capabilities associated with each candidate vehicle and assign at least one candidate vehicle to service each route segment of the vehicle route. The operations computing system 104 can communicate data indicative of the service request for the candidate vehicles (e.g., directly and/or indirectly to the vehicles, etc.). In this manner, the operations computing system 104 can be configured to facilitate a transportation service utilizing multiple vehicles, where appropriate.

More particularly, the operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), coordination of vehicle services, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102 and/or vehicle capabilities data associated with the capabilities of vehicles include the vehicle 102. The vehicle status data, for example, can include a state of a vehicle, a location of a vehicle (e.g., a latitude and longitude of a vehicle), the availability of a vehicle (e.g., whether a vehicle is available to pick-up or drop-off passengers and/or cargo, etc.), the status of one or more vehicle systems, the status of one or more autonomous robots, and/or the state of objects internal and/or external to a vehicle (e.g., the physical dimensions and/or appearance of objects internal/external to the vehicle). The vehicle capabilities data, for example, can include one or more operational capabilities associated with a vehicle.

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102; and/or the like. The one or more remote computing devices 106 can communicate (e.g., exchange data and/or signals) with one or more devices including the operations computing system 104 and the vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with another computing device or computing system (e.g., the operations computing system 104). Further, the one or more remote computing devices 106 can be used to determine and/or modify one or more states of the vehicle 102 including a location (e.g., a latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, truck, etc.), an aircraft, and/or another type of vehicle (e.g., watercraft, bicycle, scooter, other light electric vehicle, etc.). The vehicle 102 can be an AV that can perform various actions including driving, navigating, and/or operating, with minimal and/or no interaction from a human driver. The AV 102 can be configured to operate in one or more modes including, for example, a fully autonomous operational mode, a semi-autonomous operational mode, a park mode, a sleep mode, and/or the like. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, the state of an environment including one or more objects (e.g., the physical dimensions and/or appearance of the one or more objects) and/or the operational capabilities of the vehicle (e.g., ability to make a left turn, U-turn, etc.) can be stored locally in one or more memory devices of the vehicle 102. Additionally, the vehicle 102 can provide data indicative of the state of the vehicle, the state of one or more passengers of the vehicle, the state of an environment and/or the operational capabilities of the vehicle to the operations computing system 104, which can store an indication, record, and/or other data indicative of the state of the vehicle, the state of one or more passengers of the vehicle, the state of an environment and/or the operational capabilities of the vehicle in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, lights, and/or other objects. The one or more sensors can be located on various parts of the vehicle 102 including a front side, rear side, left side, right side, top, or bottom of the vehicle 102. The autonomy sensor data 116 can be indicative of locations associated with the one or more objects within the surrounding environment of the vehicle 102 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan. One or more of the perception system 124, prediction system 126, and/or motion planning system 128 (and/or the functions thereof) can be combined into a single system and/or share one or more computing resources.

The perception system 124 can identify one or more objects that are proximate to the vehicle 102 (e.g., within a sensors field of view, range, etc.) based on autonomy sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around a vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (the state data 130 and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the AV 102 based at least in part on the current locations and/or predicted future locations and/or moving paths of the objects. For example, the cost function can describe a cost (e.g., over time) of adhering to a particular candidate motion plan. For example, the cost described by a cost function can increase when the vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the AV 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems onboard the vehicle 102. The communications system 136 can also be configured to enable the AV to communicate with and/or provide and/or receive data and/or signals from a remote computing device 106 associated with a user, an item (e.g., an item to be picked-up for a courier service), and/or the like. The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., operator's seat, etc.). Additionally, or alternatively, a display device can be viewable by a user of the vehicle 102 that is located in the rear of the vehicle 102 (e.g., a passenger seat).

The vehicle computing system 112 can communicate data between the vehicle 102 and the human-machine interface 140. The data can be communicated to and/or from the vehicle 102 directly and/or indirectly (e.g., via another computing system). For example, in some implementations, the data can be communicated directly from the vehicle computing system 112 to the human-machine interface 140. In addition, or alternatively, the vehicle computing system 112 can communicate with the human-machine interface 140 indirectly, via another computing system, such as, for example, a system of a third party vehicle provider/vendor.

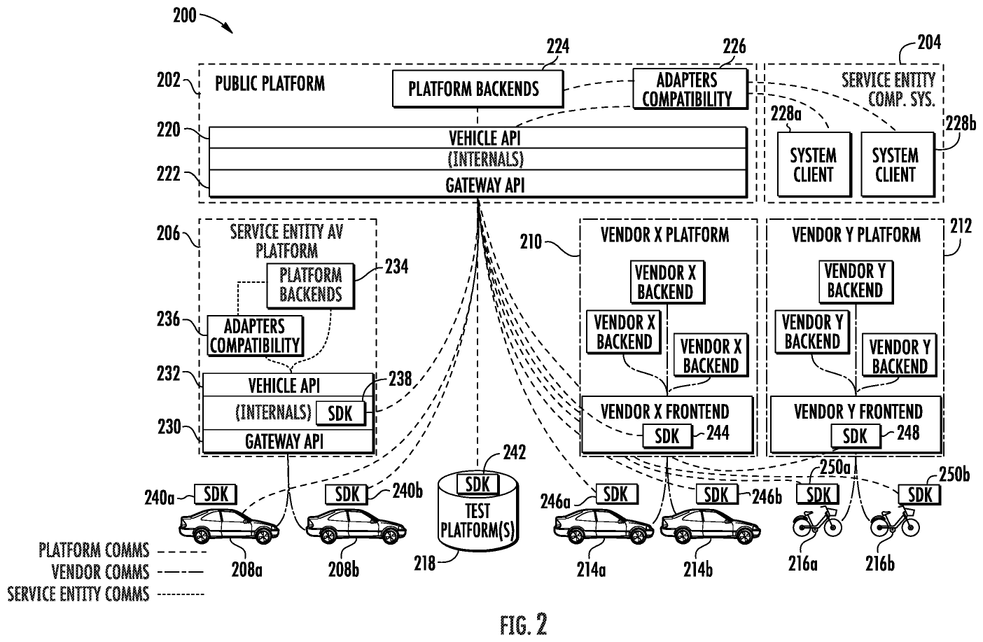

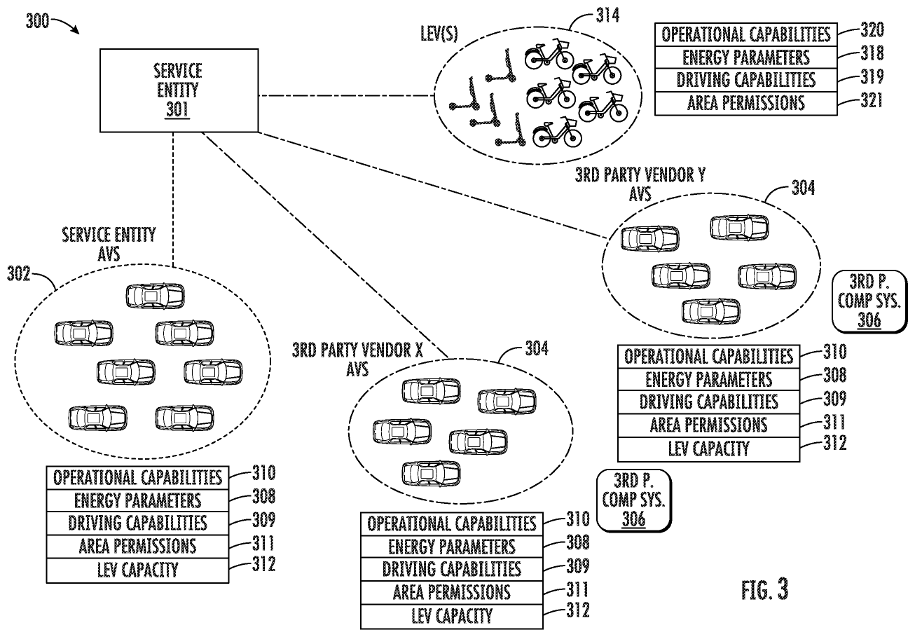

FIG. 2 depicts an example service infrastructure 200 according to example embodiments of the present disclosure. As described below, the service infrastructure 200 can include one or more components that are included in an operations computing system 104 for providing the type of vehicle services and control of the present disclosure.

As illustrated in FIG. 2, an example service infrastructure 200, according to example embodiments of the present disclosure, can include an application programming interface platform (e.g., public platform) 202, a service entity system 204, a service entity AV platform (e.g., private platform) 206, one or more service entity AVs (e.g., first party AVs in a service entity fleet) such as AVs 208a and 208b, and one or more test platforms 218. For example, the service entity may own, lease, etc. a fleet of AVs that can be managed by the service entity (e.g., its backend system clients) to provide one or more vehicle services. The AV(s) 208a, 208b utilized to provide the vehicle service(s) can be included in this fleet of the service entity. Such AV may be referred to as “service entity AVs” or “first party AVs.” Additionally, the service infrastructure 200 can also be associated with and/or in communication with one or more third-party entity systems such as vendor platforms 210 and 212, and/or one or more third-party entity AVs (e.g., in a third-party entity AV fleet) such as AVs 214a, 214b. For instance, the AV 214a, 214b can be associated with a third party vehicle provider such as, for example, an individual, an original equipment manufacturer (OEM), a third party vendor, or another entity. These AVs may be referred to as “third party AVs.” Even though such an AV 214a, 214b may not be included in the fleet of AVs of the service entity, the service entity infrastructure 200 can include a platform that can allow the AV(s) 214a, 214b associated with a third party to still be utilized to provide the vehicle services offered by the service entity, access the service entity's system clients, and/or the like.

Similarly, the service infrastructure 200 can also be associated with and/or in communication with one or more third-party entity systems such as vendor platforms 210 and 212, and/or one or more third-party entity LEVs (e.g., in a third-party entity LEV fleet) such as LEVs 216a, 216b. For instance, the LEV 216a, 216b can be associated with a third party vehicle provider such as, for example, an individual, an original equipment manufacturer (OEM), a third party vendor, or another entity. These LEVs may be referred to as “third party LEVs.” Even though such an LEV 214a, 214b may not be included in a fleet of LEVs of the service entity, the service entity infrastructure 200 can include a platform that can allow the LEVs 214a, 214b associated with a third party to still be utilized to provide the vehicle services offered by the service entity, access the service entity's system clients, and/or the like.

In some implementations, the VIP component described herein can include one or more of the platforms and related components illustrated in the service infrastructure 200 of FIG. 2. As described herein, a service infrastructure 200 can include a public platform 202 to facilitate vehicle services (e.g., provided via one or more system clients (228a, 228b) associated with a service entity operations computing system) between the service entity infrastructure system 204 (e.g., operations computing system, etc.) and vehicles associated with one or more entities (e.g., vehicles associated with the service entity (208a, 208b), vehicles associated with third-party entities (214a, 214b, 216a, 216b), etc.). For example, in some embodiments, the public platform 202 can provide access to services (e.g., associated with the service provider system 204) such as trip assignment services, routing services, supply positioning services, payment services, and/or the like.

The public platform 202 can include a gateway API (e.g., gateway API 222) to facilitate communication from the AVs to the service entity infrastructure services (e.g., system clients 228a, 228b, etc.) and a vehicle API (e.g., vehicle API 220) to facilitate communication from the service entity infrastructure services (e.g., system clients 228a, 228b, etc.) to the vehicles (e.g., 208a, 208b, 214a, 214b, 216a, 216b). For example, the public platform 202, using the vehicle API 220, can query the vehicles (e.g., 208a, 208b, 214a, 214b, 216a, 216b) and/or third party systems/platforms to determine an availability (e.g., to accept a vehicle service assignment, vehicle operational capability, etc.). The vehicles and/or other systems can transmit data (e.g., availability data, operational capability data, etc.) to the public platform 202 using the gateway API 222.

In some embodiments, the public platform 202 can be a logical construct that contains all vehicle and/or service facing interfaces. The public platform 202 can include a plurality of backend services interfaces (e.g., public platform backend interfaces 224). Each backend interface 224 can be associated with at least one system client (e.g., service provider system 204 clients such as system clients 228a and 228b). A system client (e.g., 228a, 228b, etc.) can be the hardware and/or software implemented on a computing system (e.g., operations computing system of the service entity) that is remote from the vehicle and that provides a particular back-end service to a vehicle (e.g., scheduling of vehicle service assignments, routing services, payment services, user services, vehicle rating services, etc.). A backend interface 224 can be the interface (e.g., a normalized interface) that allows one application and/or system (e.g., of the AV) to provide data to and/or obtain data from another application and/or system (e.g., a system client). Each backend interface 224 can have one or more functions that are associated with the particular backend interface. A vehicle can provide a communication to the public platform 202 to call a function of a backend interface. In this way, the backend interface(s) 224 can be an external facing edge of the service entity infrastructure system 204 that is responsible for providing a secure tunnel for a vehicle and/or other system to communicate with a particular service provider system client (e.g., 228a, 228b, etc.) so that the vehicle and/or other system can utilize the backend service associated with that particular service entity system client (e.g., 228a, 228b, etc.), and vice versa.

In some embodiments, the public platform 202 can include one or more adapters 226, for example, to provide compatibility between one or more backend interfaces 224 and one or more service entity system clients (e.g., 228a, 228b, etc.). In some embodiments, the adapter(s) 226 can provide upstream and/or downstream separation between the service entity operations computing system 204 (e.g., operations computing system 104, system clients 228a, 228b, etc.) and the public platform 202 (e.g., backend interfaces 224, etc.). In some embodiments, the adapter(s) 226 can provide or assist with data curation from upstream services (e.g., system clients), flow normalization and/or consolidation, extensity, and/or the like.

The service infrastructure 200 can include a private platform 206 to facilitate service provider-specific (e.g., internal, proprietary, etc.) vehicle services (e.g., provided via one or more system clients (228a, 228b) associated with the service entity operations computing system (e.g., operations computing system 104, etc.) between the service entity infrastructure system 204 and vehicles associated with the service entity (e.g., vehicles 208a, 208b). For example, in some embodiments, the private platform 206 can provide access to service entity services that are specific to the service entity vehicle fleet (e.g., first party AVs 208a and 208b) such as fleet management services, autonomy assistance services, and/or the like.

The private platform 206 can include a gateway API (e.g., gateway API 230) to facilitate communication from the vehicles 208a, 208b to one or more service entity infrastructure services (e.g., via the public platform 202, via one or more service entity AV backend interfaces 234, etc.) and a vehicle API (e.g., vehicle API 232) to facilitate communication from the service entity infrastructure services (e.g., via the public platform 202, via one or more service provider vehicle backend interfaces 234, etc.) to the vehicles 208a, 208b. The private platform 206 can include one or more backend interfaces 234 associated with at least one system client (e.g., service provider vehicle-specific system clients, such as fleet management, autonomy assistance, etc.). In some embodiments, the private platform 206 can include one or more adapters 236, for example, to provide compatibility between one or more service entity vehicle backend interfaces 234 and one or more private platform APIs (e.g., vehicle API 232, gateway API 230).

In some embodiments, the service infrastructure 200 can include a test platform 218 for validating and vetting end-to-end platform functionality, without use of a real vehicle on the ground. For example, the test platform 218 can simulate trips and/or support fully simulated trip assignment and/or trip workflow capabilities.

The service infrastructure 200 can be associated with and/or in communication with one or more third-party entity systems, such as third-party entity (e.g., Vendor X) platform 210 and third-party entity (e.g., Vendor Y) platform 212, and/or one or more third-party entity vehicles (e.g., in a third-party entity vehicle fleet) such as third-party vehicles 214a, 214, 216a, and 216b. The third-party entity platforms 210, 212 can be distinct and remote from the service provide infrastructure and provide for management of vehicles associated with a third-party entity fleet, such as third-party entity (e.g., Vendor X) AVs 214a, 214b and third-party entity (e.g., Vendor Y) LEVs 216a, 216b. The third-party entity (e.g., Vendor X) platform 210 and third-party entity (e.g., Vendor Y) platform 212, and/or third-party entity (e.g., Vendor X) AVs 214a, 214b and third-party entity (e.g., Vendor Y) LEVs 216a, 216b can communicate with the service entity operations computing system 204 (e.g., system clients, operations computing system 104, etc.) via the public platform 202 to allow the third-party entity platforms and/or vehicles to access one or more service entity infrastructure services (e.g., trip services, routing services, payment services, user services, etc.) and provide data to the service entity infrastructure (e.g., telemetry, location tracking, charge levels, etc.).

The service infrastructure 200 can include a plurality of software development kits (SDKs) (e.g., set of tools and core libraries), such as SDKs 238, 240a, 240b, 242, 244, 246a, 246b, 248, 250a, and 250b, that provide access to the public platform 202 for use by both the service provider AVs (208a, 208b) and the third-party entity vehicles (214a, 214b, 216a, 216b). In some implementations, all external communication with the platforms can be done via the SDKs. For example, the provider entity infrastructure can include both a public SDK and a private SDK and specific endpoints to facilitate communication with the public platform 202 and the private platform 206, respectively. In some embodiments, the service entity vehicle fleet (e.g., vehicle 208a, 208b) and/or test platform 218 can use both the public SDK and the private SDK, whereas the third-party entity vehicles (vehicle 214a, 214b, 216a, 216b) can use only the public SDK and associated endpoints. In some implementations, the SDKs can provide a single entry point into the service entity infrastructure (e.g., public platform 202, etc.), which can improve consistency across both the service provider fleet and the third-party entity fleet(s). As an example, a public SDK can provide secured access to the public platform 202 by both service entity vehicles and third-party entity (and/or systems) and access to capabilities such as trip assignment, routing, onboarding new vehicles, supply positioning, monitoring and statistics, a platform sandbox (e.g., for integration and testing), and/or the like. The private SDK can be accessed by the service entity vehicles and provide access to capabilities such as remote assistance, vehicle management, operational data access, fleet management, and/or the like.

In some embodiments, the SDKs can include a command-line interface to provide an entry point into the SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap an SDK, download components, and/or access a service entity's services. For example, based on the authentication certificate, a command-line interface can determine which version of the SDK (e.g., public or private) to which to provide access.

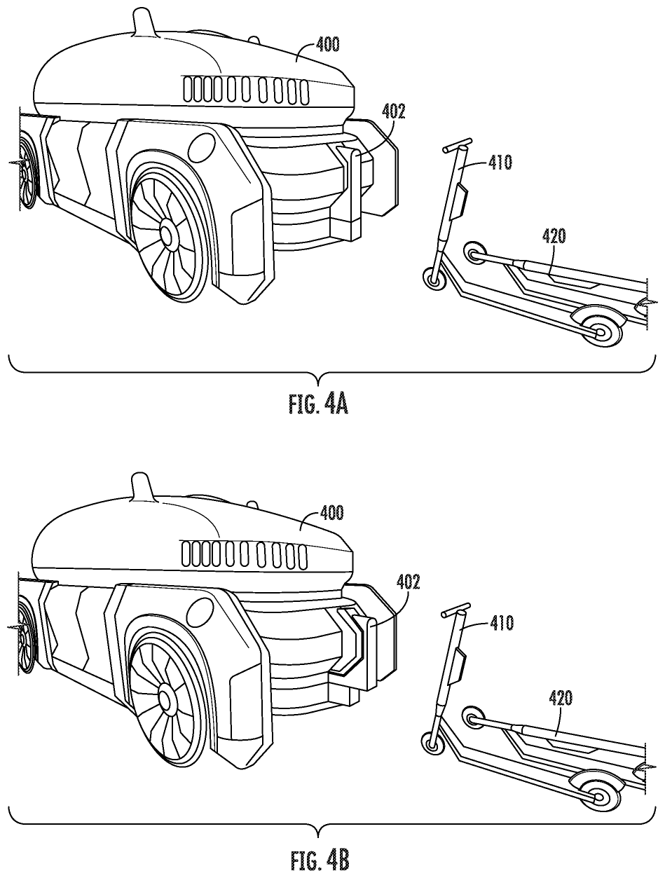

FIG. 3 depicts an example system 300 including various types of vehicle service providers according to example embodiments of the present disclosure. For example, the operations computing system 104 can determine how many vehicles (e.g., service entity AVs 302, third party AVs 304, and/or LEVs 314) may need to be utilized for servicing the service request. For instance, the operations computing system 104 can determine a vehicle route that can be serviced by more than one vehicle (e.g., service entity AVs 302, third party AVs 304, and/or LEVs 314) in a plurality of vehicles such as by different vehicle types (e.g., an LEV 314 in conjunction with a service entity AV 302 and/or a third party AV 304). The plurality of vehicles can include vehicles that are online with a service entity 301 and available to perform a vehicle service, as further described herein.

A third party vehicle system 306/308 can be, for example, a third party vehicle vendor, operator, manager, etc. that owns, operates, manages, etc. a fleet of third party AVs. The third party vehicle system 306/308 can make its fleet (or a portion of its fleet) of third party AVs available to the service entity 301 such that the third party AVs are available for performing vehicle services (e.g., to address a service request). Each of the one or more vehicle providers can be associated with one or more fleets of vehicles. In some implementations, each respective vehicle in the plurality of vehicles can be associated with at least one of the one or more fleets of vehicles associated with the one or more vehicle providers.

Each vehicle e.g., service entity AVs 302, third party AVs 304, and/or LEVs 314) can be associated with a particular fleet of vehicles based on one or more shared attributes such as, for example, a manufacturer of the vehicle (e.g., make, model, etc.), a type of the vehicle (non-autonomous, autonomous, etc.), a vehicle provider, and/or other factors sufficient to separate the plurality of vehicles. For example, in some implementations, each fleet of AVs can be associated with one or more operational capabilities 310. For example, each of the one or more fleets of AVs can be associated with a set of operational capabilities. In some implementations, the operational capabilities 310 of each AV in a respective fleet of AVs can correspond to the set of operational capabilities associated with the respective fleet of vehicles. Similarly, the operational capabilities 320 of each LEV in a respective fleet of LEVs can correspond to the set of operational capabilities 320 associated with the respective fleet of LEVs. As further described herein, the operational capabilities 310/320 of a vehicle and/or a fleet can indicate the driving capabilities 309/319 (e.g., autonomy capabilities, etc.) the vehicle/fleet is able to perform, the capabilities 309/319 the vehicle/fleet are unable to perform, areas 311/321 in which the vehicle/fleet are able and/or permitted to operate, areas 311 in which the vehicle/fleet are unable and/or restricted from operating, etc.

Similarly, each fleet of AVs can be associated with one or more energy parameters 308. For example, each of the one or more fleets of AVs can be associated with a set of energy parameters 308. In some implementations, the operational capabilities 310 of each AV in a respective fleet of AVs can correspond to the set of operational capabilities associated with the respective fleet of vehicles. Similarly, the operational capabilities 320 of each LEV in a respective fleet of LEVs can correspond to the set of operational capabilities 320 associated with the respective fleet of LEVs. As further described herein, the operational capabilities 310/320 of a vehicle and/or a fleet can indicate the driving capabilities 309/319 (e.g., autonomy capabilities, etc.) the vehicle/fleet is able to perform, the capabilities 309/319 the vehicle/fleet are unable to perform, areas 311/321 in which the vehicle/fleet are able and/or permitted to operate, areas 311 in which the vehicle/fleet are unable and/or restricted from operating, etc.

In addition, an AV operational capability can be a feature, function, and/or behavior of the AV. Each of the one or more driving capabilities 310 can be indicative of one or more restricted driving maneuvers the AV is unable to perform and/or one or more autonomous driving maneuvers that AV is able to perform. The operational capabilities 310 can include, for example; speed limits and directions (e.g., conformity to specified speed limits, directions of travel, lane restrictions, etc.); stop and go traffic (e.g., ability to properly handle dense traffic conditions with frequent slow-downs, starts, stops, etc.); turning (e.g., ability to handle left hand turns, unprotected turns, three point turns, U-turns, etc.); parking (e.g., parallel parking, required parking space dimensions, etc.); navigating certain geographic features (e.g., crossing train tracks); traveling in reverse (e.g., backing into a parking space); signaling (e.g., handling turn signal(s) from other objects); nudging (e.g., lateral movement within lane boundaries and/or partially over a lane boundary, etc.); handling jaywalkers; and/or other capabilities of an AV. In some implementations, an operational capability can depend on another operational capability. For example, the AV's ability to handle stop-and-go traffic can depend on its ability to handle speed limits and direction.

The operational capabilities 310 can be included in a pre-defined group (e.g., list, table, etc.) of AV capabilities. For instance, the one or more capabilities can be indicative of a list of capabilities. Each list of capabilities can include one or more maneuvers that the vehicle can safely perform. In some implementations, the absence of a vehicle maneuver from the list of capabilities can be indicative of a restriction. For example, in some implementations, the list of capabilities can be an exhaustive list of driving maneuvers that can be safely performed by a respective vehicle.

In addition, or alternatively, each of the one or more area permissions/restrictions 311/321 can be indicative of one or more geographic areas in which an AV is permitted to travel. For instance, the one or more area permissions 311/321 can be indicative of operating conditions, routes, and/or the like where one or more vehicles of the AVs 302/304 and/or LEVs 314 can safely operate. By way of example, the one or more area permissions 311 can be indicative of one or more geographic regions that an AV is mapped to travel within. In some implementations, if an AV does not have access to mapping data describing a geographic region, the AV may not be associated with area permissions 311 indicative of the geographic region.

Each of the vehicles (e.g., service entity AVs 302, third party AVs 304, and/or LEVs 314) may correspond to energy parameters 308/318. The energy parameters 308/318 for an AV and/or LEV may include at least one of a charge level, an energy consumption rate, an energy charging rate, and/or the like. In one example, an energy parameter 318 corresponds to a charge level of the LEV. The charge level of the LEV may include a present and/or future charge level. For instance, a future charge level may be estimated to consider the charge expended to unite the LEV with the AV. In one example, an energy parameter 308 corresponds to a projected charge level of an AV 302/304 determined to account for charge distributed to one or more onboard LEVs. Thus, an energy parameter 308 may be cooperatively determined with an energy parameter 318 based on a projected use for the respective AV 302/304 and LEV 314 (e.g., based on lengths of route segments respectively determined for traversing by the AV 302/304 and LEV 314).

Each of the AVs 302/304 may also be associated with an LEV capacity 312. An LEV capacity 312 may be indicative of an ability of an AV 302/304 to carry an LEV 314; a type of LEV 314 which may be carried by the AV 302/304; how many LEVs 314 which may be carried at once; etc. The LEV capacity 312 may also be indicative of a type of LEV storage available (e.g., internal storage; external storage; etc.) for coordination of assistance in uniting an AV 302/304 with an LEV 314 as discussed above. For instance, the LEV capacity 312 may signify to the operations computing system 104 information for providing instructions to one or more users for loading an LEV 314 into an AV 302/304.

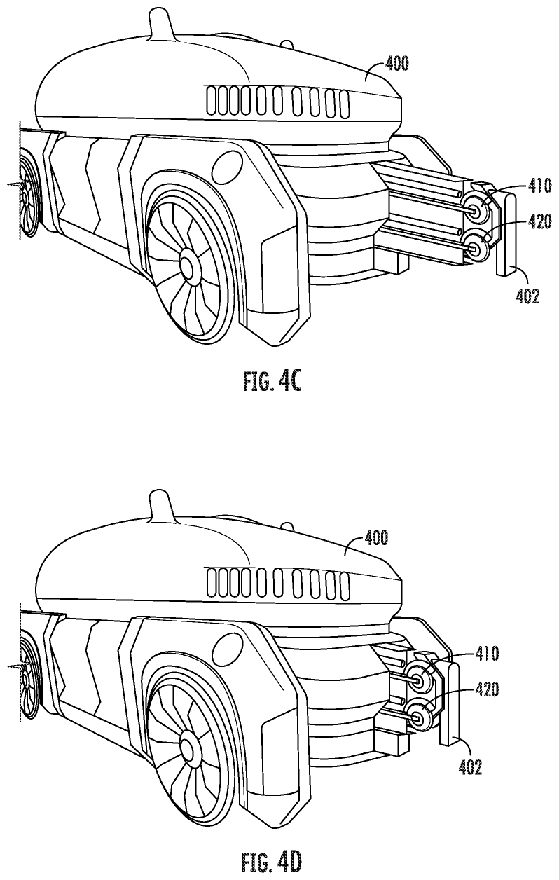

For example, FIGS. 4A-4D depict one example embodiment of an AV 400 configured to carry two LEVs 410 and 420. The LEVs 410 and 420 are shown in an example embodiment as foldable scooters: In FIGS. 4A-4B, LEV 410 is shown in the normal riding position, whereas LEV 420 is shown in a folded position. The AV 400 may be configured with an access 402 which may open to provide access to a cargo area within the AV. For example, FIG. 4C shows an embodiment in which the access 402 hinges on one end to provide an opening into which the folder LEVs 410 and 420 may be inserted. In another embodiment, shown in FIG. 4D, the access 402 may form part of a sliding panel which extends out of the AV 400 and carries the LEVs 410 and 420 fastened thereto.

The access 402 may be opened manually (e.g., via a latch or handle) or automatically. In some examples, the access 402 may be opened responsive to a signal from a user device. In one example, the user device may be nearby, such as the user device of a user travelling with the vehicle service. When the user arrives at a transfer location, the user may disembark the AV 400 and indicate (e.g., via an app associated with the service entity administering the operations system 104 and/or the public platform 202) that the user is ready to retrieve the LEV(s) 410 or 420 from the AV 400 via the access 402. In some examples, users may bring LEVs 410 or 420 for uniting with the AV 400, as described above. Upon arrival with the LEV 410 or 420 at the location of the AV 400, a user may engage an app associated with the service entity to provide a signal to the AV 400 to open the access 402.

For example, the AV 400 may receive a signal indicative of an instruction to open the access 402. The signal may be transmitted directly from the user device to the AV 400, in some embodiments, although the signal may also or alternatively be transmitted via a network to the operations computing system 104 for communication to the AV 400. For example, for third party AVs 400, a user device may optionally communicate with the operations system 104 and/or the public platform 202 (e.g., via an app associated with the service entity administering the operations system 104 and/or the public platform 202). The third party AV 400 may then receive a communication from the public platform 202 (e.g., as described above) to trigger the opening of the access 402. Embodiments of the present disclosure provide for the opening of the access 402 in a secure fashion to correspond to authorized and/or recognized users.

The user device may also display information for the user to assist in the loading and/or unloading of the LEVs 410 and 420. For example, an app on the user device (e.g., installed thereon or streaming thereto) may display instructional graphics and/or videos to indicate the steps to be taken by the user for the loading/unloading of the LEV 410 or 420, as appropriate. It is further contemplated that the user device and/or the AV 400 may indicate to the user which of the LEVs 410 and 420 may possess a higher or otherwise sufficient charge for providing the desired vehicle service, as appropriate. For example, when a user is unloading an LEV 410 or 420 at a transfer location, the user device may indicate to the user that LEV 420 possesses a full charge, and LEV 420 should be retrieved for providing the next leg of the vehicle service. Additionally, or alternatively, the AV 400, the LEVs 410 and 420, and/or the user device may independently or cooperatively inhibit or otherwise prevent the user from unloading an LEV that has insufficient charge for providing the desired vehicle service. For instance, the AV 400 may cause an indicator to indicate (e.g., a light) which LEV should be unloaded, and the user device may alternatively or additionally display a diagram indicating the same LEV. The AV 400 may, in some examples, physically lock or capture any LEV that does not contain sufficient charge, so that the user may only be able to unload the intended LEV for servicing the next leg of the vehicle service route.

The depicted embodiments are not to be understood as limiting, as it is to be understood that the LEVs 410 and 420 may be carried and/or otherwise attached to or united with the AV 400 in a number of configurations, such as within a trunk, hatch, on an bumper/hitch rack, on a roof rack, etc. For example, the LEVs 410 and 420 may optionally be carried by the AV 400 in any manner known for the vehicular transportation of bicycles and/or scooters.

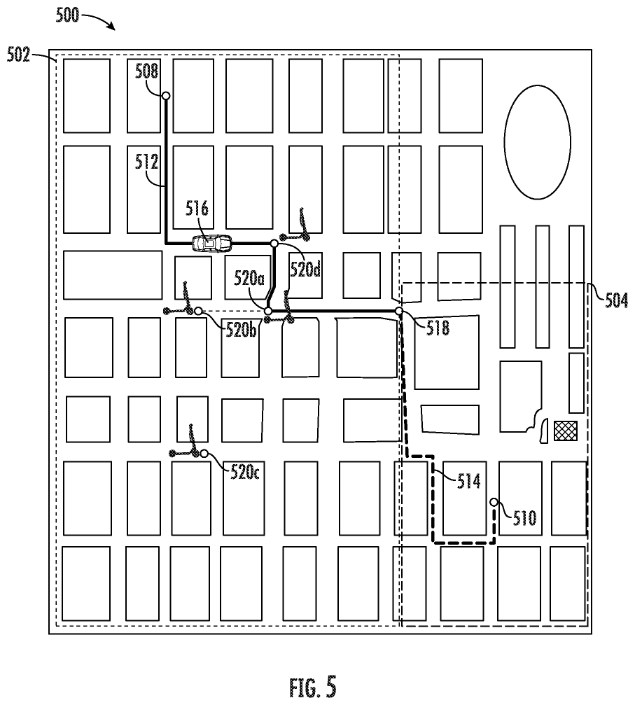

FIG. 5 depicts an example geographic area 500, including a vehicle service route (e.g., vehicle route, the one or more ancillary vehicle routes, etc.) for a vehicle service with a transfer location according to example embodiments of the present disclosure. The operations computing system 104 can determine a number of a plurality of vehicles for the service request by identifying a plurality of candidate vehicles (e.g., AVs, LEVs) available to complete the service. For example, the operations computing system 104 can identify the plurality of candidate vehicles from a plurality of AVs and LEVs associated with the one or more vehicle providers. Each candidate vehicle in the plurality of candidate vehicles can be available to perform at least one portion of the vehicle route. This can include being signed online with the service platform of the service entity to be available to receive data for performing a vehicle service and not currently performing a vehicle service (e.g., transporting a user and/or item, etc.) or at least being substantially complete with a current vehicle service such that the vehicle will become available within a reasonable time period for another assignment. In some implementations, the operations computing system 104 can identify the plurality of candidate vehicles based at least in part on a location associated with each of the plurality of vehicles. By way of example, the plurality of candidate vehicles can include a plurality of vehicles within a threshold distance from the start location 508 and/or the end location 510 of a service request.

The operations computing system 104 can segment the vehicle route into one or more route segments (e.g., first segment 512, second segment 514) based at least in part on one or more operational capabilities and/or one or more area permissions associated with one or more areas (e.g., area) associated with each candidate vehicle in the plurality of candidate vehicles. As discussed above, each vehicle in the plurality of vehicles can be associated with one or more operational capabilities and/or area permissions (e.g., associated with area 502 and/or area 504). In this manner, the operations computing system 104 can differentiate between one or more vehicles based on their capabilities and/or permissions. This, in turn, can allow the operations computing system 104 to leverage different types of vehicles to service a wide geographic area. For example, some AVs can be configured to offer better types of services such as, urban transportation, interstate transportation, transportation to airports, etc. By way of example, in some implementations, the operations computing system 104 can pool together multiple service requests into a single segmented route that utilizes multiple urban vehicles configured to pool passengers to a joint interstate transportation vehicle (e.g., a fuel efficient hybrid vehicle, etc.). Thus, by segmenting a vehicle route based on the operational capabilities and/or area permissions of a plurality of candidate vehicles, the operations computing system 104 can effectively utilize the computing resources made available by a fleet of vehicles rather than focusing on one vehicle to service an entire route.

The operations computing system 104 can determine the number of vehicles for the service request based on the vehicle route, the one or more operational capabilities associated with each vehicle in the plurality of vehicles, and/or one or more convenience factors associated with at least one user of the service request. For example, the operations computing system 104 can determine the lowest number of candidate vehicles necessary to complete the service request based at least in part on the operational capabilities associated with each of the candidate vehicles.

For example, if one candidate vehicle (e.g., an AV 516) can complete every driving maneuver (e.g., U-turn, right turn, etc.) needed to complete one route segment of the route and is permitted to travel in the area (e.g., urban area, interstate, etc.) through which the one route segment travels, the operations computing system 104 can determine that vehicle for servicing at least that one route segment of the service request. For example, a service request may correspond to a vehicle transportation service between an origin 508 and a destination 510. An AV 516 may be mapped to travel within an area 502 which includes at least a portion of a vehicle service route connecting the origin 508 and the destination 510. For instance, for the example vehicle service route shown in FIG. 5, the AV 516 may be determined by the operations computing system 104 to service the segment of the route 512 between the origin 508 and the location 518, which is located near the boundary of the area 502 and another area 504. The other area 504 may not allow AVs (e.g., an area permission incompatibility) or the AV 516 may not be mapped to travel within the area 504. However, the area 504 may be accessible by an LEV. Thus, the operations computing system 104 may determine an LEV to traverse the second segment of the route 514. The person(s) travelling with the vehicle service may transfer from the AV 516 to an LEV at the transfer location 518.

FIG. 5 shows one example wherein a plurality of LEVs are available for servicing the second route segment 514: e.g., the LEVs at locations 520a-d. The operations computing system 104 may determine at least one of these LEVs for servicing the second route segment 514 and to accompany the AV 516 on at least a portion of the first route segment 512. For example, the operations computing system 104 may communicate with an LEV at location 520a to determine whether the LEV at location 520a has sufficient charge to complete route segment 514. The charge level determined may include a level of charge to be contributed by the AV 516 while traversing the remainder of the first route segment 512. For instance, even if the LEVs at locations 520a and 520d had the same level of charge, the LEV at 520d would accompany the AV 516 along a longer portion of the route segment 512 and may thus receive a greater amount of change from the AV 516. For this reason, in some examples, the operations computing system 104 may determine the LEV at the location 520d instead of the LEV at location 520a. Other potential reasons to choose between the LEVs at the locations 520a and 520d include without limitation the traffic around locations 520a/520d, incident reports associated with the locations, areas for the AV 516 to pull off the road for uniting with the LEV, etc.

Additionally, or alternatively, the operations computing system 104 may communicated with the LEV at location 520b to determine whether it will likely, in the future, intercept the path of the AV 516 at location 520a. For instance, the operations computing system 104 may provide an incentive to a rider of the LEV currently at location 520b to ride the LEV to the location 520a for uniting with the AV 516 to accompany the AV 516 on the portion of the first route segment 512 which travels between location 520a and location 518. In some examples, a user in the vicinity of location 520c (e.g., who habitually is in the vicinity, who is actually in the vicinity, etc.) who desires to travel near the vicinity of 520a may receive a communication (e.g., on a user device) indicative of an incentive to ride the LEV at location 520c to the vicinity of the location 520a for uniting of the LEV with the AV 516. For example, the operations computing system may recognize that the user often travels from around the location 520c to around the location 520a and will likely be receptive and/or responsive to an incentive to ride the LEV between the two locations. It is to be understood, however, that the example embodiments discussed with respect to FIG. 5 are for explanation only, and that the aspects of the systems and methods of the present disclosure pertaining to the uniting of LEVs and AVs are not limited by the examples depicted.

The operations computing system 104 can communicate data associated with the service request for the at least two candidate vehicles. Data sent for the candidate vehicles can be sent directly to the candidate vehicles and/or to a remote computing system that is associated with the respective candidate vehicle and remote from the candidate vehicle. The data indicative of the service request can include a request and/or a command for the candidate vehicle to service a particular segment of the route (e.g., vehicle route, one or more ancillary route, etc.). For example, the data indicative of the service request can include a request for a third party vehicle (e.g., vehicles owned by a third party service provider, etc.) to service the request. In another example, the data indicative of the route (e.g., vehicle route, one or more ancillary, etc.) can include a command for a first party vehicle operated by the service entity to service the request.

The operations computing system 104 of the service entity 301 can obtain data indicative of an acceptance or rejection of the service assignment. In the event a service assignment is rejected, the operations computing system 104 can select another candidate vehicle to service the rejected route segment and/or determine one or more new route segments (e.g., for a previously selected candidate vehicle or a new candidate vehicle).

By way of example, the operations computing system 104 can obtain data indicative of a rejection of the route segment/vehicle service assignment (e.g., from a candidate AV/LEV, from a vehicle provider computing system, etc.). In some implementations, the operations computing system 104 can select another candidate AV/LEV for the route segment. For instance, the operations computing system can analyze the operational capabilities of a third candidate AV/LEV to determine whether the third candidate AV/LEV can traverse the route segment (that was rejected for the second candidate AV/LEV). In the event the third candidate AV/LEV is determined to be able to traverse the route segment, the operations computing system can select the third AV/LEV and communicate data indicative of the route segment (e.g., second service assignment) for the third candidate AV/LEV.

Additionally, or alternatively, the operations computing system 104 can perform another segmenting of the route based at least in part on the rejection. For example, the operations computing system can determine that another candidate AV/LEV (e.g., the third AV/LEV) cannot traverse the AV/LEV route segment based at least in part on the operational capabilities of the third AV/LEV or determine that it would not be appropriate for the AV/LEV candidate AV/LEV to do so (e.g., because of its location, traffic, etc.). The operations computing system 104 can perform another segmenting process of the route to segment the route into one or more new segments that are different than the previous route segment(s). The operations computing system 104 can select one or more AVs/LEVs for these new route segments. The selected AV(s)/LEV(s) may or may not include the first candidate AV/LEV (that previously accepted the route segment(s)) and/or a third candidate AV/LEV. In the event that the route is re-segmented, the operations computing system 104 can cancel the first service assignment communicated to the first candidate AV/LEV. The operations computing system 104 can repeat this process until all the route segments are accepted by candidate AVs/LEVs (so that the entire route can be completed). In some implementations, the operations computing system 104 can select a candidate AV/LEV for a route segment after another AV/LEV has accepted and begun to traverse another route segment. In some implementations, the operations computing system 104 can maintain the first route segment and then break the second route segment (the rejected one) into one or more sub-segments and select candidate AV(s)/LEV(s) to service those segments (e.g., based at least in part on the operational capabilities of those AVs/LEVs). In the event the number of transfer locations changes, the user(s) may be provided a discount, incentive, etc.

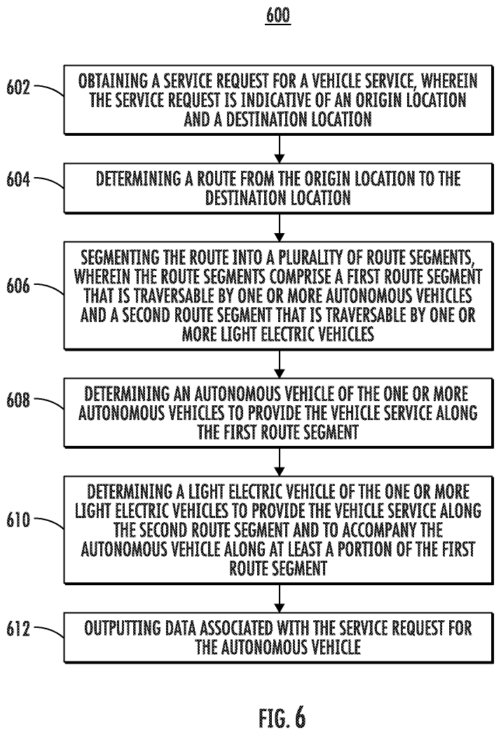

FIG. 6 depicts an example flow diagram of an example method 600 according to example implementations of the present disclosure. One or more portion(s) of the method 600 can be implemented by a computing system that includes one or more computing devices such as, for example, the computing systems described with reference to the other figures (e.g., the vehicle computing system 112, the operations computing system 104, etc.). Each respective portion of the method 600 can be performed by any (or any combination) of one or more computing devices. Moreover, one or more portion(s) of the method 600 can be implemented as an algorithm on the hardware components of the device(s) described herein, for example, to control and autonomous vehicle/light electric vehicle and coordinate the provision of vehicle services. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for exemplary illustrated purposes and is not meant to be limiting. One or more portions of method 600 can be performed additionally, or alternatively, by other systems.

At (602), the method 600 can include obtaining a service request for a vehicle service. For example, the operations computing system can receive a service request for a vehicle service. The service request, for example, can include a start location and an end location. In addition, or alternatively, the service request can include one or more user preferences, projected route features, and/or other information, for example, as described herein.

At (604), the method 600 can include determining a vehicle route from a start location to an end location. For example, the operations computing system can determine a vehicle route from the start location to the end location. The vehicle route can include one or more directions (e.g., driving, aerial, etc.) to enable a vehicle to travel from the start location to the end location.

At (606), the method 600 can include segmenting the vehicle service route into one or more route segments. One route segment (e.g., a first route segment) may be traversable by one or more AVs. Another route segment (e.g., a second route segment) may be traversable by one or more LEVs. In some embodiments, the method at 606 can include determining the first route segment based at least in part on one or more autonomy capabilities of the one or more AVs, and/or determining the second route segment based at least in part on an accessibility of the destination location by the one or more LEVs. In some embodiments, the method at 606 can further include determining an incompatibility between the one or more AVs and at least one portion of the second route segment. For example, the incompatibility can comprise a least one of a vehicle service route limitation, an ordinance limitation, a mapping limitation, or a driving limitation.

At (608), the method 600 can include determining an AV of the one or more AVs that can traverse the first route segment. In some examples, the method 600 at 608 can include determining a subset of the one or more AVs carrying at least one LEV.

At (610), the method 600 can include determining an LEV of the one or more LEVs that can traverse the second route segment. The LEV can be determined to traverse the second route segment and accompany the AV (e.g., the AV determined to traverse the first route segment) along at least a portion of the first route segment. In some examples, the method 600 at 610 can include determining a location of the LEV a distance from a location of the AV. For instance, the LEV may be determined at least in part based on a proximity of the LEV to a point along an initial route of the AV to the origin location or to a point along the first route segment. In some embodiments, the method 600 at 610 can further include determining a charge level of the LEV sufficient to traverse the second route segment (e.g., including a future charge level based at least in part on a charge amount to be contributed by the AV).

At (612), the method 600 can include outputting data associated with the service request for the AV. For example, the operations computing system can communicate data associated with the service request via an operations computing system 104 and/or a service infrastructure 200. For example, the service infrastructure 200 can communicate and/or otherwise distribute data associated with the service request to first-party and/or third-party vehicles.

In some embodiments, the method 600 can further include determining a query for submitting to a device associated with a user of the vehicle service (e.g., a query comprising information corresponding to an option to traverse the second route segment with the LEV), and receiving a response to the query (e.g., a response corresponding to a user input indicative of a decision to select the option).

In some embodiments, the method 600 can further include determining information for display to a user of the vehicle service. The information can comprise at least one data item selected from a map of the first route segment, a map of the second route segment, an estimated travel time, or an identifying characteristic of the LEV. In some embodiments, the method 600 can further include determining a communication indicative of a reward. For instance, the reward may be conditioned on the retrieval of the LEV for uniting with the AV. A recipient of the communication indicative of the reward may be determined at least in part based on a proximity of the recipient to the LEV.

By way of example, each of the one or more route segments can be indicative of at least two legs. In such a case, the operations computing system can determine that the first candidate vehicle is capable of servicing the at least two legs of the first route segment based, at least in part, on the first set of operational capabilities. In addition, the operations computing system can determine that the second candidate vehicle is capable of servicing the at least two legs of the second route segment based, at least in part, on the second set of operational capabilities.

In some implementations, at least one of the candidate vehicles assigned to perform the vehicle service can be included in a first AV fleet of a first vehicle provider. In addition, at least one of the candidate vehicles assigned to perform the vehicle service can be included in a second AV fleet of a second vehicle provider. For example, the first fleet of AVs can be associated with a first set of operational capabilities. In addition, the second fleet of AV can be associated with a second set of operational capabilities. In some implementations, at least a subset of the first set of operational capabilities can be different than at least a subset of the second set of operational capabilities.

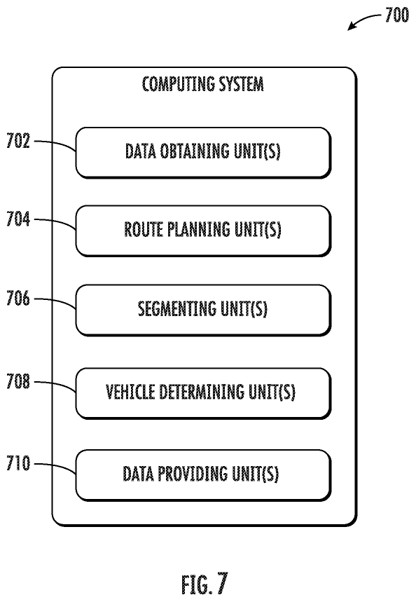

Various means can be configured to perform the methods and processes described herein. For example, FIG. 7 depicts an example system 700 that includes various means according to example embodiments of the present disclosure. The computing system 700 can be and/or otherwise include, for example, an operations computing system, deployment system (backend service), etc. The computing system 700 can include data obtaining unit(s) 702, route planning unit(s) 704, segmenting unit(s) 706, vehicle determining unit(s) 708, data providing unit(s) 710, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s) 702, etc.) can be configured to obtain data representing one or more service requests. For example, each service request can be associated with a vehicle service for a user and can include a start location and an end location. In addition, in some implementations, the means (e.g., the data obtaining unit(s) 702, etc.) can obtain vehicle data indicative of one or more operational capabilities associated with a plurality of vehicle and map data indicative of one or more geographic areas.

In addition, the means (e.g., route planning unit(s) 704, etc.) can be configured to determine a vehicle route from the start location to the end location associated with a service request. For example, the means (e.g., route planning unit(s) 704, etc.) can determine the vehicle route based on map data indicative of one or more geographic areas including the start location and the end location of the service request. The vehicle route, for example, can include driving directions sufficient to direct a vehicle from the start location to the end location.

In addition, the means (e.g., segmenting unit(s) 706, etc.) can be configured to segment the vehicle service route into a plurality of route segments. The route may be segmented such that at least one route segment is traversable by one or more AVs (e.g., in view of operational capabilities, convenience factors, etc.) to form a first route segment and at least one other route segment is traversable by one or more LEVs (e.g., in view of operational capabilities, safety factors, convenience factors, etc.) to form a second route segment. For example, the means (e.g., segmenting unit(s) 706, etc.) can be configured to segment the vehicle service route into one or more route segments based on one or more operational capabilities associated with each AV in a plurality of AVs and/or each LEV in a plurality of LEVs. In addition, or alternatively, the means (e.g., segmenting unit(s) 706, etc.) can be configured to segment the vehicle service route into one or more route segments based on one or more convenience factors associated with the service request. In some implementations, the means (e.g., segmenting unit(s) 706, etc.) can be configured to determine one or more ancillary routes. Each ancillary route, for example, can include a different number of segments. The one or more ancillary routes can be generated based on the convenience factors associated with the service request.

In addition, the means (e.g., vehicle determining unit(s) 708, etc.) can be configured to determine an AV of the one or more AVs to provide the vehicle service along the first route segment. By way of example, the means (e.g., vehicle determining unit(s) 708, etc.) can be configured to determine that an AV is capable of servicing the first route segment of the vehicle service route. The means (e.g., vehicle determining unit(s) 708, etc.) can also be configured to determine that an AV is capable of conveying an LEV to the start of the second route segment for providing the vehicle service along the second route segment. The means (e.g., vehicle determining unit(s) 708, etc.) can determine a vehicle to service a particular route segment based on such a determination.

In addition, the means (e.g., vehicle determining unit(s) 708, etc.) can be configured to determine an LEV of the one or more LEVs to provide the vehicle service along the second route segment. The LEV may further be determined to accompany an AV of the one or more AVs along at least a portion of the first route segment such that the LEV is conveyed by the AV to the start of the second route segment.

In addition, the means (e.g., data obtaining unit(s) 702, data providing unit(s) 710, etc.) can be configured to communicate data associated with the service request. For example, the means (e.g., data providing unit(s) 710, etc.) can communicate data associated with a request and/or a command for one or more vehicles to service at least one segment of the vehicle service route (e.g., an AV to service a first route segment and/or an LEV to service a second route segment). In addition, or alternatively, the means (e.g., data providing unit(s) 710, etc.) can be configured to provide transit data indicative of the service request to a user of a user device. In this manner, the means (e.g., data providing unit(s) 710, etc.) can inform a user of one or more segments and/or candidate vehicle determined for the vehicle route. In some examples, the means (e.g., data obtaining unit(s) 702, etc.) may also obtain data corresponding to a user input associated with one or more routes (e.g., vehicle service routes, ancillary vehicle service routes) and/or convenience factors associated therewith.

These described functions of the means are provided as examples and are not meant to be limiting. The means can be configured for performing any of the operations and functions described herein.

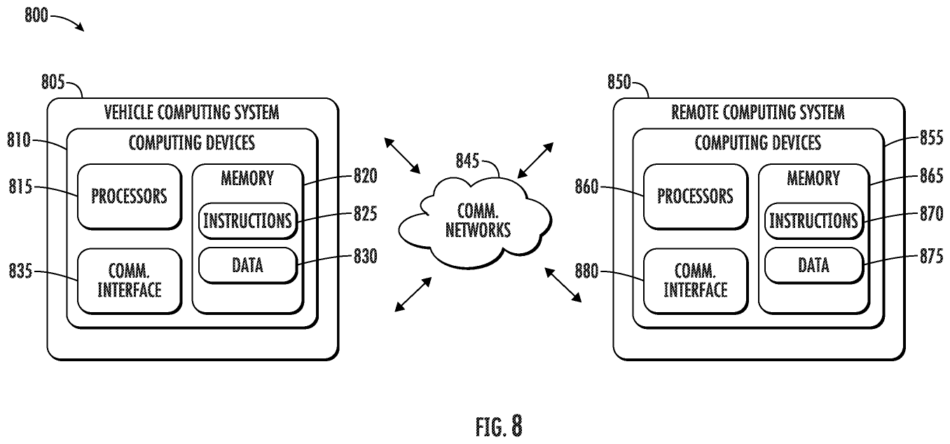

FIG. 8 depicts example system components of an example system 800 according to example implementations of the present disclosure. The example system 800 illustrated in FIG. 8 is provided as an example only. The components, systems, connections, and/or other aspects illustrated in FIG. 8 are optional and are provided as examples of what is possible, but not required, to implement the present disclosure. The example system 800 can include a vehicle computing system 805 (e.g., vehicle computing system 112, etc.) and a remote computing system 850 (e.g., operations computing system 104, remote computing device(s) 106, etc.) that are communicatively coupled over one or more network(s) 845 (e.g., network 108, etc.). As described herein, the vehicle computing system 805 can be implemented onboard a vehicle (e.g., as a portion of the vehicle computing system 112) and/or can be remote from a vehicle (e.g., as a portion of an operations computing system 104, one or more remote computing devices(s) 106 etc.).

The vehicle computing system 805 can include one or computing device(s) 810. The computing device(s) 810 of the vehicle computing system 805 can include processor(s) 815 and a memory 820. The one or more processor(s) 815 can be any suitable processing device (e.g., a processor core, a microprocessor, an ASIC, a FPGA, a controller, a microcontroller, etc.) and can be one processor or a plurality of processors that are operatively connected. The memory 820 can include one or more non-transitory computer-readable storage media, such as RAM, ROM, EEPROM, EPROM, one or more memory devices, flash memory devices, etc., and/or combinations thereof.

The memory 820 can store information that can be obtained by the one or more processor(s) 815. For instance, the memory 820 (e.g., one or more non-transitory computer-readable storage mediums, memory devices, etc.) can include computer-readable instructions 825 that can be executed by the one or more processor(s) 815. The instructions 825 can be software written in any suitable programming language or can be implemented in hardware. Additionally, or alternatively, the instructions 825 can be executed in logically and/or virtually separate threads on processor(s) 815.

For example, the memory 820 can store instructions 825 that when executed by the one or more processor(s) 815 cause the one or more processor(s) 815 (e.g., of the vehicle computing system 112) to perform operations such as any of the operations and functions of the operations computing system 104 and/or for which the operations computing system 104 is configured, as described herein, the operations for vehicle control and allocation for the provision of vehicle services (e.g., one or more portions of method 600), the operations and functions of any of the models described herein and/or for which the models are configured and/or any other operations and functions for the operations computing system 104, as described herein.

The memory 820 can store data 830 that can be obtained (e.g., received, accessed, written, manipulated, generated, created, stored, etc.). The data 830 can include, for instance, sensor data 116, map data 122, state data 130, prediction data 132, motion planning data 134, data associated with one or more user(s) (user preferences, etc.), data associated with one or more service assignments(s) (start location, end location, convenience factors, etc.), data associated with one or more AVs (e.g., AV operational capabilities, vehicle location, etc.), data associated with one or more LEVs, data associated with routes or route segments, and/or other data/information described herein. In some implementations, the computing device(s) 810 can obtain data from one or more memories that are remote from the vehicle computing system 805.

The computing device(s) 810 can also include a communication interface 835 used to communicate with one or more other system(s) (e.g., other systems onboard and/or remote from a vehicle, the other systems of FIG. 8, etc.). The communication interface 835 can include any circuits, components, software, etc. for communicating via one or more network(s) (e.g., network(s) 845). In some implementations, the communication interface 835 can include, for example, one or more of a communications controller, receiver, transceiver, transmitter, port, conductors, software and/or hardware for communicating data/information.

The remote computing system 850 can include one or more computing device(s) 855. The computing device(s) 855 can include one or more processor(s) 860 and at least one memory 865. The one or more processor(s) 860 can be any suitable processing device (e.g., a processor core, a microprocessor, an ASIC, a FPGA, a controller, a microcontroller, etc.) and can be one processor or a plurality of processors that are operatively connected. The memory 865 can include one or more tangible, non-transitory computer-readable storage media, such as RAM, ROM, EEPROM, EPROM, one or more memory devices, flash memory devices, data registers, etc., and combinations thereof.

The memory 865 can store information that can be accessed by the one or more processor(s) 860. For instance, the memory 865 (e.g., one or more tangible, non-transitory computer-readable storage media, one or more memory devices, etc.) can include computer-readable instructions 870 that can be executed by the one or more processor(s) 860. The instructions 870 can be software written in any suitable programming language or can be implemented in hardware. Additionally, or alternatively, the instructions 870 can be executed in logically and/or virtually separate threads on processor(s) 860.

For example, the memory 865 can store instructions 870 that when executed by the one or more processor(s) 860 cause the one or more processor(s) 860 to perform operations such as any of the operations and functions of the vehicle computing system 805, the remote computing system 850 and/or computing device(s) 855, or for which any of these computing systems are configured, as described herein, one or more portions of the method 600 as further described herein, operations and functions of the operations computing system 104, and/or any other operations and functions described herein.

The memory 865 can store data 875 that can be obtained and/or stored. The data 875 can include, for instance, services data (e.g., vehicle service data, convenience factors, route data, user data, infrastructure system requirement data, etc.), data associated with AVs (e.g., vehicle data, maintenance data, ownership data, sensor data 116, map data 122, prediction data 132, motion planning data 134, object states and/or state data 130, object motion trajectories, feedback data, log data, etc.), data associated with one or more AVs (e.g., AV capabilities, vehicle location, etc.), data associated with one or more LEVs, data associated with routes or route segments, and/or other data/information as described herein. In some implementations, the computing device(s) 855 can obtain data from one or more memories that are remote from the remote computing system 850.

The computing device(s) 855 can also include a communication interface 880 used to communicate with one or more other system(s) (e.g., the vehicle computing system 805, etc.). The communication interface 880 can include any circuits, components, software, etc. for communicating via one or more networks (e.g., network(s) 845). In some implementations, the communication interface 880 can include, for example, one or more of a communications controller, receiver, transceiver, transmitter, port, conductors, software, and/or hardware for communicating data.

The network(s) 845 can be any type of network or combination of networks that allows for communication between devices. In some embodiments, the network(s) 845 can include one or more of a local area network, wide area network, the Internet, secure network, cellular network, mesh network, peer-to-peer communication link and/or some combination thereof and can include any number of wired or wireless links. Communication over the network(s) 845 can be accomplished, for instance, via a network interface using any type of protocol, protection scheme, encoding, format, packaging, etc.

Computing tasks discussed herein as being performed at computing device(s) remote from an AV can instead be performed at the vehicle (e.g., via the vehicle computing system 800), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method comprising:
obtaining, by a computing system comprising one or more computing devices, a service request for a vehicle service, wherein the service request is indicative of an origin location and a destination location;
determining, by the computing system, a route from the origin location to the destination location;
segmenting, by the computing system, the route into a plurality of route segments, wherein the route segments comprise a first route segment that is traversable by one or more autonomous vehicles and a second route segment that is traversable by one or more light electric vehicles;
determining, by the computing system, an autonomous vehicle of the one or more autonomous vehicles to provide the vehicle service along the first route segment;
determining, by the computing system, a light electric vehicle of the one or more light electric vehicles to provide the vehicle service along the second route segment and to accompany the autonomous vehicle along at least a portion of the first route segment; and
outputting, by the computing system, data associated with the service request for the autonomous vehicle.

2. The computer-implemented method of claim 1, wherein segmenting, by the computing system, the route into the plurality of route segments comprises:
determining, by the computing system, the first route segment based at least in part on one or more autonomy capabilities of the one or more autonomous vehicles.

3. The computer-implemented method of claim 1, wherein segmenting, by the computing system, the route into the plurality of route segments comprises:
determining, by the computing system, the second route segment based at least in part on an accessibility of the destination location by the one or more light electric vehicles.

4. The computer-implemented method of claim 1, wherein segmenting, by the computing system, the route into the plurality of route segments comprises:
determining, by the computing system, an incompatibility between the one or more autonomous vehicles and at least one portion of the second route segment.

5. The computer-implemented method of claim 4, wherein the incompatibility comprises a least one of a vehicle service route limitation, an ordinance limitation, a mapping limitation, or a driving limitation.

6. The computer-implemented method of claim 1, wherein determining, by the computing system, the autonomous vehicle of the one or more autonomous vehicles to provide the vehicle service along the first route segment comprises:
determining, by the computing system, a subset of the one or more autonomous vehicles carrying at least one light electric vehicle.

7. The computer-implemented method of claim 1, wherein determining, by the computing system, the light electric vehicle of the one or more light electric vehicles comprises:
determining, by the computing system, a location of the light electric vehicle a distance from a location of the autonomous vehicle, wherein the light electric vehicle is determined at least in part based on a proximity of the light electric vehicle to a point along an initial route of the autonomous vehicle to the origin location or to a point along the first route segment.

8. The computer-implemented method of claim 1, wherein determining, by the computing system, the light electric vehicle of the one or more light electric vehicles comprises:
determining, by the computing system, a charge level of the light electric vehicle sufficient to traverse the second route segment.

9. The computer-implemented method of claim 8, wherein the charge level is a future charge level based at least in part on a charge amount to be contributed by the autonomous vehicle.

10. The computer-implemented method of claim 1, further comprising:
determining, by the computing system, a query for submitting to a device associated with a user of the vehicle service, wherein the query comprises information corresponding to an option to traverse the second route segment with the light electric vehicle; and
receiving, by the computing system, a response to the query, wherein the response corresponds to a user input indicative of a decision to select the option.

11. The computer-implemented method of claim 1, further comprising:
determining, by the computing system, information for display to a user of the vehicle service, the information comprising at least one data item selected from a map of the first route segment, a map of the second route segment, an estimated travel time, or an identifying characteristic of the light electric vehicle.

12. The computer-implemented method of claim 7, further comprising:
determining, by the computing system, a communication indicative of a reward, wherein the reward is conditioned on the retrieval of the light electric vehicle for uniting with the autonomous vehicle.

13. The computer-implemented method of claim 12, wherein a recipient of the communication indicative of the reward is determined at least in part based on a proximity of the recipient to the light electric vehicle.

14. The computer-implemented method of claim 1, further comprising:
determining, by the computing system, a transfer location which coincides with the first route segment and the second route segment, wherein the transfer location is determined based at least in part on at least one of a safety factor or a convenience factor.

15. A computing system, comprising:
one or more processors; and
one or more tangible, non-transitory, computer readable media that collectively store instructions that when executed by the one or more processors cause the computing system to perform operations, the operations comprising:
obtaining a service request for a vehicle service, wherein the service request is indicative of an origin location and a destination location;
determining a route from the origin location to the destination location;
segmenting the route into a plurality of route segments, wherein the route segments comprise a first route segment that is traversable by one or more autonomous vehicles and a second route segment that is traversable by one or more light electric vehicles;
determining an autonomous vehicle of the one or more autonomous vehicles to provide the vehicle service along the first route segment;
determining a light electric vehicle of the one or more light electric vehicles to provide the vehicle service along the second route segment and to accompany the autonomous vehicle along at least a portion of the first route segment; and
outputting data associated with the service request for the autonomous vehicle.

16. The computing system of claim 15, wherein determining the light electric vehicle of the one or more light electric vehicles comprises:
determining at least one of a location of the light electric vehicle external to the autonomous vehicle or a charge level of the light electric vehicle.

17. The computing system of claim 15, wherein the operations further comprise:
determining a communication indicative of a reward, wherein the reward is conditioned on the retrieval of the light electric vehicle for uniting with the autonomous vehicle.

18. The computing system of claim 17, wherein a recipient of the communication indicative of a reward is determined at least in part based on a user account associated with a service entity that coordinates the vehicle service.

19. An autonomous vehicle comprising:
one or more processors; and
one or more memory devices, the one or more memory devices storing instructions that when executed by the one or more processors cause the one or more processors to perform operations, the operations comprising:
receiving communications corresponding to a route from an origin location to a destination location, wherein the route comprises a first route segment that is traversable by the autonomous vehicle and a second route segment that is traversable by one or more light electric vehicles; and
determining a light electric vehicle of the one or more light electric vehicles to provide the vehicle service along the second route segment and to accompany the autonomous vehicle along at least a portion of the first route segment, wherein the light electric vehicle is determined at least in part based on a proximity of the light electric vehicle to a point along an initial route to the origin location or to a point along the first route segment.

20. The autonomous vehicle of claim 19, wherein the operations further comprise:
determining a charge level of the light electric vehicle sufficient to traverse the second route segment, wherein the charge level is a future charge level based at least in part on a charge amount to be contributed by the autonomous vehicle; and
initiating a charging action to provide power to the light electric vehicle.
